(19) United States
(12) Patent Application Publication
(10) Pub. No.: US 2026/0213529 A1
(43) Pub. Date: Jul. 23, 2026

(54) SYSTEM AND METHOD FOR DIRECT CURRENT POWER GENERATION AND MANAGEMENT

(71) Applicant: King Fahd University of Petroleum and Minerals, Dhahran (SA)

(72) Inventors: Mohamed Abdelfattah Zaery Mohamed ALI, Dhahran (SA); Mohammad Ali ABIDO, Dhahran (SA)

(73) Assignee: King Fahd University of Petroleum and Minerals, Dhahran (SA)

(21) Appl. No.: 19/181,482

(22) Filed: Apr. 17, 2025

Related U.S. Application Data
(60) Provisional application No. 63/746,638, filed on Jan. 17, 2025.

(51) Int. Cl. H02J 1/00; H02J 13/13

(52) U.S. Cl. CPC H02J 1/00; H02J 13/1337

(57) ABSTRACT

A direct current (DC) power generation system includes a DC microgrid (MG) operating in an islanding mode. The system further includes a distributed control system for controlling operation of the DC MG. The DC MG includes distributed generators (DGs) interconnected through transmission lines for supplying local loads. The distributed control system includes a primary controller and a secondary controller. The distributed control system further includes a cyber network for communication between the plurality of DGs, cyber links used in the cyber network having time delays. Within a predefined settling time that is independent of initial conditions, the secondary controller manages power allocation among the DGs and regulates an average voltage of the DC MG, taking account of the time delays. The primary controller performs droop control for the DGs within the DC MG.

### CROSS REFERENCE TO RELATED APPLICATIONS

The present application claims priority to Provisional Application No. 63/746,638, filed on Jan. 17, 2025, the contents of which are incorporated herein in their entirety.

### STATEMENT REGARDING PRIOR DISCLOSURE BY THE INVENTORS

Aspects of this technology are described in an article by Mohamed Zaery and Mohammad A. Abido, titled “Distributed Optimal Power Dispatch for Islanded DC Microgrids With Time Delays,” published on IEEE Access, Vol. 12, 2024, the entire content of which is herein incorporated by reference.

### STATEMENT OF ACKNOWLEDGEMENT

Support provided by King Fahd University of Petroleum and Minerals (KFUPM) is gratefully acknowledged.

### BACKGROUND

### Technical Field

The present disclosure is directed to power control systems, and more particularly, to systems and methods for direct current (DC) power generation and management in islanded microgrids (MGs).

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

With the rapid rise in the deployment of distributed generators (DGs) and electronic loads, microgrids (MGs) have emerged as a vital concept for enhancing the flexibility, resilience, and efficiency of modern electrical distribution networks. The MGs are generally classified into alternating current (AC) and direct current (DC) types based on the nature of connected DGs and loads. Among the AC MGs and DC MGs, the DC MGs offer several advantages over the AC MGs, such as higher efficiency, simpler control architectures, and immunity to issues like inrush currents, reactive power control complexities, and frequency synchronization challenges. Additionally, the DC MGs are capable of operating in both grid-connected and islanded modes, making the DC MGs well-suited for diverse applications, including remote and isolated areas.

In islanded DC MGs, optimal power sharing between the DGs is crucial to ensure a balance between generation and demand while minimizing a total generation cost (TGC). The optimal power-sharing problem is widely known as an economic dispatch (ED) problem. Conventionally, the ED problem has been addressed using centralized optimization techniques such as dynamic programming, lambda iteration, particle swarm optimization, and evolutionary algorithms. While these centralized techniques can be effective, they rely on a central controller to collect global information and issue control commands to all the DGs. In addition, the centralized techniques introduce vulnerabilities such as a single point of failure and increased cyber-network complexity, which limit scalability and reliability, particularly in large-scale MGs.

To overcome some of these issues, hierarchical control frameworks have also been utilized. The hierarchical control frameworks include multiple control layers (e.g., primary, secondary, and tertiary levels) to separate fast and local control from slower, system level optimization processes. Although the hierarchical control frameworks improve modularity and enhance system resilience relative to purely centralized structures, they still often rely on upper-level coordinators or supervisory controllers, which may become bottlenecks under dynamic conditions or critical points of failure.

Decentralized control strategies have also been proposed to mitigate these challenges, where individual local controllers make decisions based on locally available data. While such decentralized control strategies improve system robustness by eliminating the single point of failure; however, many conventional decentralized control strategies suffer from slow convergence rates or yield suboptimal solutions due to insufficient coordination among the DGs. Several distributed control strategies have been utilized to improve ED performance in the islanded DC MGs. In one conventional approach, a distributed control method that minimizes generation cost while restoring MG's average voltage has been described (See: Wang, Z et al., “A Distributed Control Method with Minimum Generation Cost for DC Microgrids,” in IEEE Transactions on Energy Conversion, vol. 31, no. 4, pp. 1462-1470 December 2016, incorporated herein by reference in its entirety). Furthermore, in another conventional approach, a unified distributed controller has been developed to minimize the TGC while satisfying equality and inequality constraints of the ED problem (See: S, Moayedi et al., “Unifying Distributed Dynamic Optimization and Control of Islanded DC Microgrids,” in IEEE Transactions on Power Electronics, March 2017, pp. 2329-2346, incorporated herein by reference in its entirety).

To enhance performance, an adaptive droop control approach has been developed for solving the ED problem in a fully distributed manner (See: J, Hu et al., “Distributed Adaptive Droop Control for Optimal Power Dispatch in DC Microgrid,” IEEE Transactions on Industrial Electronics, vol. 65, no. 1, pp. 778-789, January 2018, incorporated herein by reference in its entirety). Further, the distributed controller focusing on economic allocation of DG output power while neglecting ED's inequality constraints has also been presented (See: Han, H et al., “Distributed control scheme on cost optimization under communication delays for DC microgrids,” IET Generation, Transmission & Distribution, vol. 11, no. 17, pp. 4193-421 November 2017, incorporated herein by reference in its entirety). Additionally, a multi-agent supervisory controller has been developed to optimize power management in the islanded DC MGs (See: A, Hamad, A et al., “Multiagent Supervisory Control for Power Management in DC Microgrids,” IEEE Transactions on Smart Grid, vol. 7, no. 2, pp. 1057-168 March 2016, incorporated herein by reference in its entirety). Another conventional approach utilized a fully distributed economic power management strategy that respects both equality and inequality constraints for optimal load dispatching in the islanded DC MGs containing renewable and nonrenewable DGs (See: A, Hamad et al., “Multi-agent Supervisory Control for Optimal Economic Dispatch in DC Microgrids,” Sustainable Cities and Society, vol. 27, pp. 129-136, November 2016, incorporated herein by reference in its entirety).

Additionally, a consensus-based fully distributed dual-layer control system has been implemented for achieving an optimal operation of the islanded DC MGs while restoring average voltage (See: D, Liu et al., “A Fully Distributed Economic Dispatch Method in DC Microgrid Based on Consensus Algorithm,” IEEE Access, vol. 10, pp. 119345-119356, 2022, incorporated herein by reference in its entirety). A distributed hierarchical control technique has been developed to minimize the operating cost of droop-based DC MGs while considering DG power limits (See: Z, Lv et al., “Distributed Economic Dispatch Scheme for Droop-Based Autonomous DC Microgrid,” Energies, vol. 13, no. 2, p. 404, January 2020, incorporated herein by reference in its entirety). Additionally, a fully distributed secondary control strategy has been proposed for regulating the average voltage of the DC MGs while minimizing the TGC (See: Y Dou et al., “Distributed Secondary Control for Voltage Regulation and Optimal Power Sharing in DC Microgrids,” IEEE Transactions on Control Systems Technology, vol. 30, no. 6, pp. 2561-2572, November 2022, incorporated herein by reference in its entirety). However, these approaches utilize linear consensus protocols with asymptotic convergence, which may be unsuitable for fast-changing operating conditions in the islanded MGs due to intermittency of renewable energy sources and demand uncertainty.

To address this, a distributed finite-time ED scheme has been introduced for optimal load allocation among the DGs in the MG with accelerated convergence while respecting both equality and inequality constraints (See: G, Chen et al., “Distributed Finite-Time Economic Dispatch of a Network of Energy Resources,” IEEE Transactions on Smart Grid, vol. 8, no. 2, pp. 822-832, March 2017, incorporated herein by reference in its entirety). Moreover, a fully distributed finite-time ED control algorithm has been proposed for minimizing the MG's TGC within a predefined settling time (See: M, Zaery et al., “Distributed Economic Dispatch for Islanded DC Microgrids Based on Finite-Time Consensus Protocol,” IEEE Access, vol. 8, pp. 192457-192468, 2020, incorporated herein by reference in its entirety). Further, a finite-time second-order cooperative control strategy has also been designed to optimize the islanded DC MG operations with fast convergence (See: Martinez Gomez et al., “Finite-Time Second-Order Cooperative Control for the Economic Dispatch in DC Microgrids,” IECON Proceedings (Industrial Electronics Conference), vol. 2020-October, pp. 1596-161 October 2020, incorporated herein by reference in its entirety). However, the dependence of finite-time protocol's settling time on initial system values limits their applicability in large-scale MGs.

To overcome this limitation, a distributed fixed-time control method has been proposed for optimally allocating loads among different DGs in the DC MGs with a preassigned fast convergence time that is independent of initial values (See: Z, Cheng et al., “Distributed fixed-time secondary control for voltage restoration and economic dispatch of DC microgrids,” Sustainable Energy, Grids and Networks, vol. 34, p. 101042, June 2023, incorporated herein by reference in its entirety). Additionally, a fixed-time secondary controller integrating voltage regulation and power optimization to eliminate voltage deviations and maintain optimal power allocation has been introduced (See: M, Zaery et al., “Fully Distributed Fixed-Time Optimal Dispatch for Islanded DC Microgrids,” Conference Proceedings-IEEE Applied Power Electronics Conference and Exposition-APEC, vol. 2020-March, pp. 603-608, March 2020, incorporated herein by reference in its entirety). However, the capability of this control strategy under cyber-physical failures and cyber delays remains unverified. Furthermore, a fixed-time control scheme has been developed to ensure proportional load sharing among the DGs in the DC MGs while considering time delays (See: Y, Feng et al., “Distributed Fixed Time Control for DC Microgrid with Input Delay,” International Transactions on Electrical Energy Systems, vol. 2023, 2023, incorporated herein by reference in its entirety). However, existing approaches do not provide an effective solution for achieving optimal economic dispatch in a fully distributed manner while accounting for cyber delays within a fixed time frame.

Thus, there is a need for a more efficient approach that addresses the limitations of existing approaches by improving convergence speed, robustness against communication and system uncertainties, and optimality of power-sharing solutions in the islanded DC MGs.

### SUMMARY

In an exemplary embodiment, a direct current (DC) power generation system is disclosed. The system includes a DC microgrid (MG) operating in an islanding mode. The system further includes a distributed control system for controlling operation of the DC MG. The DC MG includes a plurality of distributed generators (DGs) interconnected through transmission lines for supplying local loads. The distributed control system includes a primary controller and a secondary controller. The distributed control system further includes a cyber network for communication between the plurality of DGs, cyber links used in the cyber network having time delays. Within a predefined settling time that is independent of initial conditions, the secondary controller manages power allocation among the plurality of DGs and regulates an average voltage of the DC MG, taking account of the time delays. The primary controller performs droop control for the plurality of DGs within the DC MG.

In another exemplary embodiment, a method for operating a direct current (DC) power generation system is disclosed. The DC power generation system includes a DC microgrid (MG) and a distributed control system. The DC MG operates in an islanding mode. The distributed control system controls operation of the DC MG. The DC MG includes a plurality of distributed generators (DGs) interconnected through transmission lines for supplying local loads. The distributed control system includes a primary controller and a secondary controller. The distributed control system includes a cyber network for communication between the plurality of DGs, cyber links used in the cyber network having time delays. The method includes within a pre-defined settling time that is independent of initial conditions, via the secondary controller, managing power allocation among the plurality of DGs. The method further includes, via the secondary controller, regulating an average voltage of the DC MG, taking account of the time delays. The method further includes via the primary controller, performing droop control for the plurality of DGs within the DC MG.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a block diagram of a direct current (DC) power generation system, according to certain embodiments.

FIG. 1B illustrates a schematic diagram of an islanded DC microgrid (MG), according to certain embodiments.

FIG. 2 illustrates a block diagram of a secondary controller of a distributed control system, according to certain embodiments.

FIGS. 3A-3C illustrates graphical representations of operation of the distributed control system under variable load conditions, according to certain embodiments.

FIGS. 4A-4C illustrates graphical representations of performance of the distributed control system while considering DGs' capacity limits, according to certain embodiments.

FIGS. 5A-5C illustrates graphical representations of plug-and-play capability of the distributed control system, according to certain embodiments.

FIGS. 6A-6C illustrates graphical representations of robustness of the distributed control system when a cyber link fails within the DC MG, according to certain embodiments.

FIGS. 7A-7C illustrates graphical representations of performance of the distributed control system under different time delays, according to certain embodiments.

FIGS. 8A-8C illustrates graphical representations of performance of fixed-time control strategies under different time delays, according to certain embodiments.

FIG. 9 illustrates a flowchart of a method for operating a direct current (DC) power generation system, according to certain embodiments.

FIG. 10 is an illustration of a non-limiting example of details of computing hardware used in a computing system, according to certain embodiments.

FIG. 11 is an exemplary schematic diagram of a data processing system used within the computing system, according to certain embodiments.

FIG. 12 is an exemplary schematic diagram of a processor used with the computing system, according to certain embodiments.

FIG. 13 is an illustration of a non-limiting example of distributed components which may share processing with a controller, according to certain embodiments.

### DETAILED DESCRIPTION

In the drawings, like reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system and method for direct current (DC) power generation and management in islanded DC microgrids (MGs), providing optimal economic operation and voltage regulation through a fully distributed control framework. Conventional decentralized approaches to the DC MGs often encounter challenges such as slow convergence rates, sub-optimal power sharing, and degraded system performance under communication time delays or nonlinear characteristics of DGs and loads. Additionally, existing fixed-time control techniques typically result in longer settling times and higher integral squared error (ISE), limiting their effectiveness in dynamic and delay-prone environments.

The present disclosure introduces a distributed fixed-time control approach for economic dispatch. This approach ensures that incremental costs (ICs) of all the DGs are equalized within a fixed time, regardless of initial system conditions and ensures compliance with DG's capacity limits throughout operation. Furthermore, a fixed-time voltage regulator is incorporated to maintain an average voltage of the MG, thereby ensuring power balance between generation and demand. To address detrimental effects of the communication time delays, the present disclosure utilizes Artstein's reduction method to convert a delayed system into an equivalent delay-free system, enhancing system stability and dynamic response. Unlike conventional approaches, the present disclosure provides a fully distributed and delay-resilient solution. The present disclosure offers superior convergence speed, robustness, and optimality, as validated through extensive simulations showing improvements over existing control strategies.

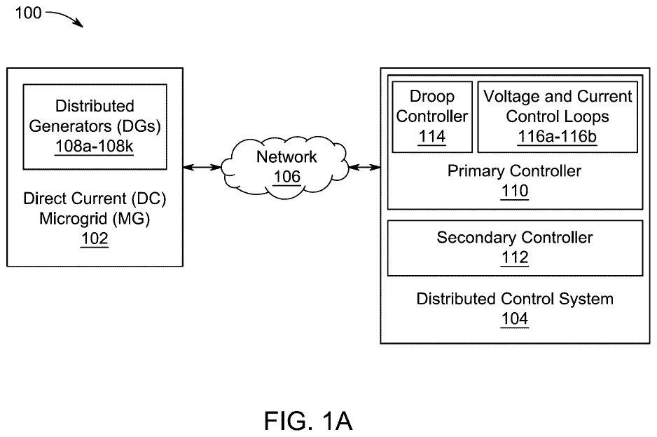

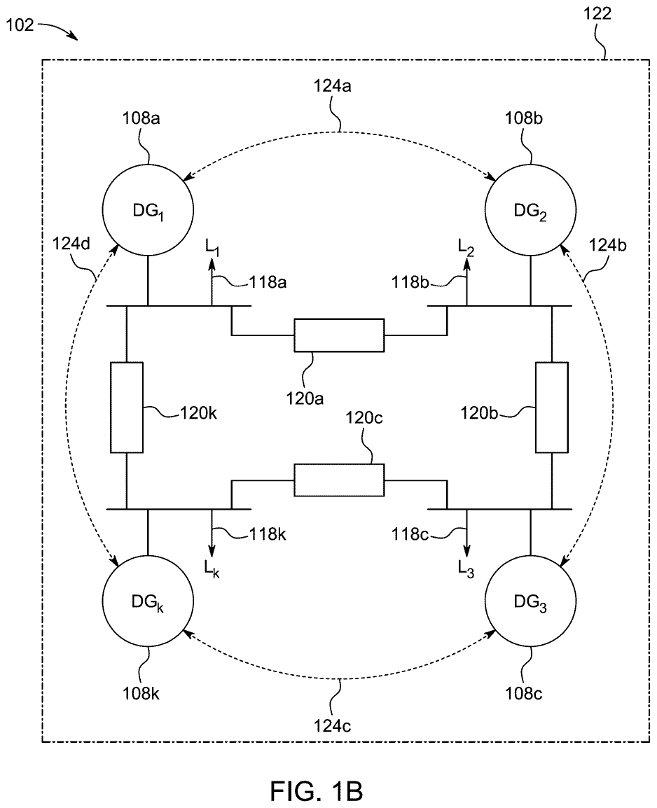

FIG. 1A illustrates a block diagram of a direct current (DC) power generation system 100, according to certain embodiments. The system 100 includes a DC microgrid (MG) 102 and a distributed control system 104. The terms “DC MG” and “MG” may be used interchangeably throughout the disclosure. In an embodiment, the MG 102 and the distributed control system 104 may be interconnected through a network 106. The network 106 facilitates data exchange between local controllers of the distributed control system 104 and corresponding distributed generators (DGs) 108a-108k within the MG 102. In one embodiment, the network 106 may be implemented as a wired communication infrastructure, such as, but not limited to, Ethernet, controller area network (CAN) bus, or other suitable wired protocols. The wired communication facilitates robust and low-latency data exchange between the distributed control system 104 and components of the MG 102 for tasks, such as, but not limited to, peer-to-peer coordination (e.g., direct communication between neighboring DGs to share operational status and balance power generation dynamically), economic dispatch (ED), voltage control (e.g., adjusting DG output to maintain a stable average voltage across the MG 102 despite load variations), and so forth. As used herein, the term “economic dispatch (ED)” refers to a process of optimally allocating power generation among a set of DGs 108a-108k to minimize total generation cost (TGC) while satisfying power demand and operational constraints.

In another embodiment, the network 106 may be implemented as a wireless communication infrastructure, such as, but not limited to, ZigBee, wireless fidelity (Wi-Fi), proprietary radio frequency (RF) mesh networks, and so forth. The wireless communication provides flexibility and scalability, particularly in applications where laying physical cables is impractical, while still enabling distributed coordination among the distributed control system 104 and the DGs 108a-108k for performing the ED and voltage regulation.

The MG 102 is a localized power distribution network where electricity is generated, distributed, and consumed in the form of direct current (DC). In an embodiment, the MG 102 may be designed to operate autonomously in an islanded mode. In another embodiment, the MG 102 may be designed to operate in a hybrid mode. As used herein, the term “islanded mode” refers to a state in which the MG 102 or distributed energy system operates independently, without being connected to a main utility grid (e.g., a large-scale national or regional power grid managed by utility companies). In the islanded mode, the MG 102 relies solely on its own distributed energy resources (such as solar photovoltaic (PV) panels, wind turbines, or generators) to generate and balance power supply with local demand (i.e., electricity consumption of connected loads that are physically located within MG's operational area, such as residential homes, commercial buildings, or industrial facilities). In an embodiment, the islanded mode is used during grid outages, in remote locations without grid access, or when autonomy is required for operational resilience and energy security. Also, as used herein, the term “hybrid mode” refers to a flexible operational state in which the MG 102 may seamlessly switch between grid-connected and islanded modes. In the hybrid mode, the MG 102 operates in coordination with the main utility grid when available, allowing for power exchange and grid support. However, during grid disturbances or outages, the MG 102 may autonomously transition to the islanded mode, relying on its own distributed energy resources for the power generation.

The MG 102 includes the DGs 108a-108k that may be interconnected through transmission lines 118a-118k (as shown in FIG. 1B) for supplying the local demand (i.e., local loads). The DGs 108a-108k may include a number of dispatchable DGs and a number of non-dispatchable DGs. The dispatchable DGs may be generators whose power output is controlled (increased or decreased) on demand to meet load requirements. The dispatchable DGs may include but are not limited to, diesel generators, gas turbines, microturbines, fuel cells, biomass generators, hydro turbines, and so forth. Embodiments of the present disclosure are intended to include or otherwise cover any type of the dispatchable DGs, including known related art and/later developed technologies. The non-dispatchable DGs may depend upon environmental conditions (such as sunlight availability for solar panels or wind speed for wind turbines) and may not be controlled easily by an operator to meet the demand instantly. The non-dispatchable DGs may include, but are not limited to, photovoltaic solar panels, wind turbines, tidal or wave energy systems, and so forth. Embodiments of the present disclosure are intended to include or otherwise cover any type of the non-dispatchable DGs, including known related art and/later developed technologies.

The distributed control system 104 is configured to control the operation of the MG 102. In an exemplary embodiment, the distributed control system 104 may be configured to coordinate optimal power sharing among the DGs 108a-108k of the MG 102 by solving an ED problem in a decentralized manner. The ED problem includes distributing the load demand among the dispatchable DGs to minimize the TGC, while also maintaining voltage stability and ensuring that each DG operates within its power generation limits.

To achieve cost-efficient power distribution in the MG 102, a decentralized optimization algorithm may be executed to equalize incremental costs (ICs) of all dispatchable DGs while ensuring that the dispatchable DGs operate within their respective capacity constraints. As used herein, the term “IC” refers to an additional cost incurred to produce one more unit of output, measured as the cost of generating an additional kilowatt (kW) of power. By ensuring IC equalization, the decentralized optimization algorithm minimizes the TGC by adjusting the power generation among the dispatchable DGs in an optimal manner. For example, if DG₁ generates the power between 10-50 KW and DG₂ generates the power between 20-80 kW, the decentralized optimization algorithm dynamically computes the ICs and redistributes power outputs accordingly. This ensures cost-effective load sharing while maintaining the total power balance of the MG 102.

In addition to managing the dispatchable DGs, the distributed control system 104 is responsible for executing power allocation decisions and ensuring stable MG operation. The distributed control system 104 dynamically adjusts the power generation of the dispatchable DGs based on demand fluctuations and implements power optimization techniques to maximize the utilization of the non-dispatchable DGs. The power optimization techniques may include, but are not limited to, adaptive power control techniques, energy storage-assisted optimization techniques, forecast-based power scheduling techniques, and other similar approaches. In a preferred embodiment, the power optimization technique may include maximum power point tracking (MPPT) techniques to ensure that the non-dispatchable DGs operate at their maximum possible output. As used herein, the term “maximum power point (MPP)” refers to optimal operating voltage and current levels at which a renewable energy source (e.g., solar PV panels and wind turbines) delivers the maximum power. In an embodiment, the MPPT techniques may dynamically adjust system parameters, such as voltage or current to track and maintain the MPP of the renewable energy sources, thereby improving efficiency and maximizing power extraction under fluctuating conditions.

Since the power generation of the non-dispatchable DGs fluctuates due to the environmental conditions, the distributed control system 104 dynamically regulates the dispatchable DGs to balance the remaining power demand efficiently. The power allocation among the dispatchable DGs is determined based on generation cost and power demand, ensuring economic efficiency. In other words, the dispatchable DGs are scheduled to compensate for the remaining power demand in a cost-effective manner.

The optimal power allocation among the dispatchable DGs is determined by solving the ED problem, where a generation cost function for each dispatchable DG is modeled as a quadratic convex function:

$${C}_{i} ( {P}_{i} ) = {a}_{i} {P}_{i}^{2} + {b}_{i} {P}_{i} + {c}_{i} , \qquad ( 1 )$$

where Cᵢ(Pᵢ) denotes the generation cost of DGᵢ and aᵢ bᵢ, and cᵢ are mandatory cost coefficients for each DG. Pᵢ denotes the generated power of DGᵢ. The cost function reflects operational expenses associated with the power generation, including fuel costs and maintenance.

To determine the optimal power allocation that minimizes the TGC, the ED problem is formulated as:

$$min ( {\sum }_{i = 1}^{K} {C}_{i} ( {P}_{i} ) ) , \qquad ( 2 )$$

$${\sum }_{i = 1}^{K} {P}_{i} = {P}_{L} - {P}_{res} = {P}_{D} , \qquad ( 3 )$$

where K denotes the total number of DGs 108a-108k in the MG 102, P_{L} denotes a total MG demand, Pᵣₑₛ denotes total power generated by non-dispatchable renewable energy sources (RES), and P_{D} denotes a net power demand after RES contribution.

Equation (3) represents a power balance constraint in the ED, ensuring that the total power generated by all dispatchable DGs (Pᵢ) matches the net load demand (P_{D}) of the system 100. Equation (3) ensures that the power supplied by the system 100 (dispatchable DGs and non-dispatchable DGs) is equal to the total MG demand.

The distributed control system 104 ensures that each DG (i.e., dispatchable DG) operates within its defined lower and upper power limits as follows:

$$\underline{{P}_{i}} \leq {P}_{i} = \overline{{P}_{l}} , \qquad ( 4 )$$

where denote Pᵢ and Pₗ denotes the lower and upper power limits of the DGᵢ.

Furthermore, to solve the ED problem, a Lagrange multiplier approach is applied to determine the optimal power allocation among the dispatchable DGs while minimizing the TGC and ensuring the power balance. The Lagrange function is defined as:

$$l ( {P}_{i} λ ) = {\sum }_{i = 1}^{N} {C}_{i} ( {P}_{i} ) + λ ( {P}_{D} - {\sum }_{i = 1}^{K} {P}_{i} ) , \qquad ( 5 )$$

where l denotes the Lagrange function, and λ denotes the IC, also known as the Lagrange multiplier, associated with the power balance constraint and representing a marginal cost of power generation.

Further, optimality conditions of the Lagrange function are derived by differentiating Equation (3) with respect to Pᵢ and λ as:

$$\frac{\partial l}{\partial {P}_{i}} = \frac{\partial {C}_{i} {P}_{i}}{\partial {P}_{i}} - λ = 0 \qquad ( 6 )$$

$$\frac{\partial l}{\partial λ} = {P}_{D} - {\sum }_{i = 1}^{N} {P}_{i} = 0 , \qquad ( 7 )$$

$$where \frac{\partial l}{\partial λ}$$

represents a partial derivative of the Lagrange function with respect to the Lagrange multiplier λ. The condition

$$\frac{\partial l}{\partial λ} = 0$$

ensures that the ED solution satisfies the power balance condition.

In an embodiment, to achieve the minimum TGC without considering DG capacity limits, the distributed control system 104 equalizes the ICs of all the DGs 108a-108k at an optimal value λ* for determining the corresponding power outputs of the DGs 108a-108k using Equation (8).

$${P}_{i} = \frac{{λ}^{*} - {b}_{i}}{2 {a}_{i}} \qquad ( 8 )$$

In another embodiment, when the DG capacity limits are considered, the optimality conditions are adjusted as shown in Equation (9):

$$\{ \begin{matrix}\frac{\partial {C}_{i} {P}_{i}}{\partial {P}_{i}} \geq λ , for {P}_{i} = \underline{{P}_{i}} \\ \frac{\partial {C}_{i} {P}_{i}}{\partial {P}_{i}} = λ , for \underline{{P}_{i}} \leq {P}_{i} = \overline{{P}_{l}} \\ \frac{\partial {C}_{i} {P}_{i}}{\partial {P}_{i}} \leq λ , for {P}_{i} = \overline{{P}_{l}}\end{matrix} \qquad ( 9 )$$

Thus, for optimal cost-efficient operation, all the dispatchable DGs that are not constrained by their power limits equalize their ICs to the optimal value, and the dispatchable DGs operating at lower or upper power limits will have incremental costs equal to their boundary values λᵢ, A̅ᵢ̅ respectively. In conclusion, for the economic operation of the MG 102, the DGs 108a-108k without active power constraints maintain the equalized ICs, while the DGs 108a-108k operating at their lower or upper power limits have ICs corresponding to the respective limits λᵢ, A̅ᵢ̅ associated with their lower (Pᵢ) or upper power limits (̅P̅ᵢ̅)̅.

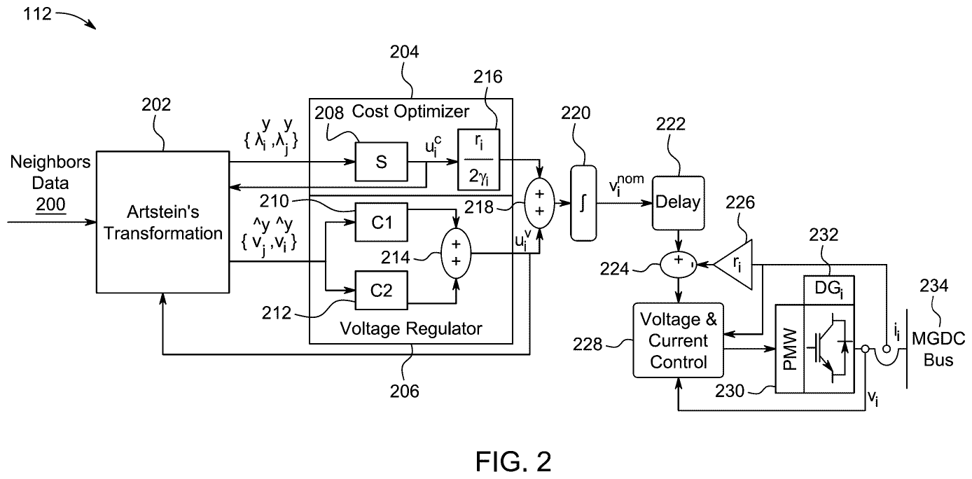

The distributed control system 104 includes a primary controller 110 and a secondary controller 112 (explained in detail in FIG. 2). In an embodiment, the secondary controller is a distributed secondary controller. The primary controller 110 is configured to regulate voltage and current to enable stable operation of the DGs 108a-108k. The voltage and current regulation refer to a process of maintaining voltage and current levels within acceptable limits to ensure reliable and efficient operation of the system 100. The voltage regulation ensures that the voltage supplied to the local loads remains within a predefined range, preventing issues such as overvoltage, which may damage equipment. The current regulation controls the current flow to prevent excessive currents that may lead to overheating, component failure, or electrical instability.

The primary controller 110 is configured to regulate the voltage and current through control mechanisms, such as, but not limited to, a droop controller 114, voltage and current control loops 116a-116b and feedback-based correction methods. In an exemplary embodiment, the droop controller 114 may dynamically adjust the voltage and frequency of each DG based on the power output of the corresponding DG to ensure proper load-sharing among multiple DGs 108a-108k. In an embodiment, the droop controller 114 may follow a predefined characteristic, where output voltage decreases slightly as the power output increases, thereby distributing the load proportionally among all the DGs 108a-108k.

In an exemplary embodiment, consider an X microgrid with three DGs supplying power to a shared load. Each DG operates with different generation capacities, and their power output fluctuates due to varying load demands. Without proper control, one DG might end up supplying more power than others, leading to imbalanced load sharing and potential instability.

To address this, the droop controller 114 is implemented. Suppose DG₁, DG₂, and DG₃ have nominal voltages of 400 Volts (V), but their power outputs vary. If DG₁ is supplying more power than its setpoint, its droop control mechanism may slightly reduce its voltage and frequency to encourage the other DGs to take on more load. Conversely, if DG₃ is supplying less power, its voltage and frequency may be increased slightly to contribute more power to the shared load.

For example, if DG₁ initially generates 50 kW while DG₂ and DG₃ generate 30 kW and KW, respectively, the droop controller 114 may gradually adjust the voltage references. As a result, DG₁ may reduce its output to 40 KW, while DG₂ and DG₃ increase to 35 kW and 25 KW, respectively, ensuring load distribution. This self-regulating mechanism allows the MG 102 to operate in a decentralized manner without requiring direct communication between the DGs 108a-108k, enhancing system stability and resilience.

Further, the voltage and current control loop 116a-116b work alongside the droop controller 114 to regulate the electrical parameters of each DG. In an exemplary embodiment, the voltage control loop 116a maintains the DG's voltage at a desired level, ensuring stability, while the current control loop 116b prevents excessive current draw, protecting both the DG and the connected loads. The droop controller 114 is configured to tune a voltage reference of the voltage control loop 116a, which means that the voltage control loop 116a does not operate with a fixed voltage reference but instead receives a dynamically adjusted voltage reference from the droop controller 114. As load conditions change, the droop controller 114 modifies the voltage reference to achieve balanced power sharing among the multiple DGs 108a-108k. For instance, if a DG X starts supplying more power than intended, the droop controller 114 may slightly lower the voltage reference of the DG X, reducing its output and encouraging other DGs to compensate. Conversely, if the DG X is underutilized, the droop controller 114 increases the voltage reference of the DG X to encourage higher power output. The primary controller 110, through the combination of the droop controller 114 and voltage and current control loops 116a-116b, provides stability, optimal power distribution, and protection against overload conditions.

The voltage reference tuning through the droop controller 114 is mathematically represented as:

$${v}_{i} = {v}_{i}^{nom} - {r}_{i} * {P}_{i} , \qquad ( 10 )$$

By substituting the value of Pᵢ from Equation (8) into Equation (10), Equation (11) is obtained as:

$${v}_{i} = {v}_{i}^{nom} - \frac{{r}_{i}}{2 {a}_{i}} * {λ}_{i} , \qquad ( 11 )$$

where vᵢ and rᵢ denote the output voltage and droop gain of DGᵢ, respectively. The term

$${v}_{i}^{nom}$$

represents a nominal reference voltage of the MG 102 defined by the secondary controller 112.

In an embodiment, the primary controller 110 may apply a feedback linearization process by differentiating Equation (11) to determine auxiliary control inputs with heterogeneous time delays. The feedback linearization process effectively transforms the system dynamics, making it more tractable for control implementation. As a result, nominal voltage dynamics may be expressed as:

$${v}_{ι}^{\dot{nom}} = \dot{{v}_{ι +}} \frac{{r}_{i}}{2 {a}_{i}} * {\dot{λ}}_{ι} = {u}_{i}^{v} ( t - {h}_{i} ) + {u}_{i}^{c} ( t - {h}_{i} ) , \qquad ( 12 )$$

$$where {v}_{i}^{nom}$$

represents a time derivative of the nominal voltage reference for DGᵢ, \dot{v}ᵢ represents a time derivative of the output voltage of DGᵢ. The auxiliary control inputs,

$${u}_{i}^{v} ( t - {h}_{i} ) = \dot{{v}_{ι}} and {u}_{i}^{c} ( t - {h}_{i} ) = \frac{{r}_{i}}{2 {a}_{i}} * {\dot{λ}}_{ι} ,$$

correspond to voltage restoration and cost optimization, respectively, while accounting for heterogeneous time delays hᵢ. Accordingly, a control input

$${v}_{i}^{nom} ( t - {h}_{i} ) ,$$

subject to non-uniform delay, is determined as:

$${v}_{i}^{nom} ( t - {h}_{i} ) = \int {u}_{i}^{v} ( t - {h}_{i} ) + {u}_{i}^{c} ( t - {h}_{i} ) ) dt \qquad ( 13 )$$

where dt represents a differential element of time in the integral. This formulation ensures that the system 100 accounts for the time delays while maintaining effective voltage regulation and optimal power distribution.

Accordingly, the secondary controller 112 determines the control inputs necessary for the voltage regulation and TGC reduction. To effectively handle the impact of input delays, Artstein's transformation 202 (as shown in FIG. 2) may be employed to suppress the time delays of a cyber network 122 (as shown in FIG. 1B). In other words, the Artstein's transformation 202 may be employed to transform an input-delayed system into a delay-free system, enabling stability analysis. Thus, for a first-order integrator system that is managing DG's IC agreement and voltage regulation, reduced control variables may be obtained as below:

$${λ}_{i}^{y} = {λ}_{i} + {\int }_{t - {h}_{i}}^{t} {u}_{i}^{c} ( s ) ds , \dot{{λ}_{ι}^{y}} = {u}_{i}^{c} ( t ) , \qquad ( 14 )$$

$${v}_{i}^{y} = {v}_{i} + {\int }_{t - {h}_{i}}^{t} {u}_{i}^{v} ( s ) ds , \dot{{v}_{ι}^{y}} = {u}_{i}^{v} ( t ) , \qquad ( 15 )$$

$$where {λ}_{i}^{y} and {v}_{i}^{y}$$

represent reduced control variables that effectively approximate the original delayed system in a delay-free form, s represents an integration variable, which varies over a time interval t-hᵢ. ds represents an infinitesimal time step in the integration process, indicating that the integral accumulates small contributions of uᵢ(s) over time t−hᵢ to t. This reduction simplifies control design and stability assessment while maintaining the desired performance of the MG 102.

FIG. 1B illustrates a schematic diagram of the MG 102, according to certain embodiments. As shown in FIG. 1B, a dotted boundary surrounding the DGs 108a-108k represents the cyber network 122 of the MG 102. The cyber network 122 is a communication backbone that enables information exchange among the DGs 108a-108k for coordinated control, optimization, and stability management.

To mathematically model the cyber network 122, the MG 102 may be represented using various graph structures, such as an undirected graph, a weighted graph, a strongly connected digraph, and so forth, depending on the nature of communication and power flow among the DGs 108a-108k. In a preferred embodiment, the MG 102 may be characterized as a directed graph G (V, E, A), where {V=V₁, V₂ . . . , Vₖ} represents a set of nodes, i.e., interconnected DGs 108a-108k (DG₁, DG₂, DG₃ and DGₖ) in the MG 102. In an exemplary embodiment, DG₁ 108a may be marked as a “Reference” DG, indicating that the DG₁ 108a serves as a primary reference generator to maintain the voltage stability and provide a control baseline for the system 100.

Additionally, E=E₁, E₂ . . . , E_{K}⊂V×V represents a set of edges corresponding to cyber links 124a-124k with time delays. The cyber links 124a-124k define an information exchange pathway between the DGs 108a-108k. These directed edges indicate which DGs communicate with each other. The cyber links 124a-124k are essential for voltage regulation (ensuring stable voltage levels across the MG 102 by enabling feedback control mechanisms), power-sharing (allowing the DGs 108a-108k to coordinate and distribute power efficiently), cost optimization (supporting ED strategies to minimize TGC), stability control (enabling distributed control strategies to enhance system reliability, especially under varying load conditions or unexpected disturbance), and so forth.

A=[aᵢⱼ]_{k*k} represents adjacency matrix containing weights of the cyber links 124a-124k, where a aᵢⱼ>0 indicates a direct cyber link between DGᵢ and DGⱼ, otherwise aᵢⱼ=0.

Further, solid lines connecting the DGs 108a-108k in FIG. 1B represent the transmission lines 118a-118k, labeled as (L₁, L₂, L₃, and Lₖ). The transmission lines 118a-118k facilitate reliable and efficient electrical power transfer between the DGs 108a-108k and the connected loads within the MG 102. For example, the transmission lines 118a-118k enable the power generated by a solar farm (DG) to be transmitted to the residential homes and commercial buildings within the MG 102, ensuring a stable and efficient power supply. Unlike the cyber links 124a-124k, the transmission lines 118a-118k are responsible for actual electrical power transmission between the DGs 108a-108k. The transmission lines 118a-118k may include, but are not limited to, copper or aluminium DC cables, busbars, overhead DC lines, flexible DC power cables, and so forth. Embodiments of the present disclosure are intended to include or otherwise cover any type of the transmission lines 118a-118k, including known related art and/or later developed technologies.

As shown in FIG. 1B, rectangular blocks interspersed between the DGs 108a-108k may represent power control devices 120a-120k, including at least one of inverters, circuit breakers, transformers, or load elements that help regulate power flow, isolate faults, and optimize energy distribution. The power control devices 120a-120k (i.e., inverters, circuit breakers, transformers, or load elements) ensure that the power is equitably shared among the DGs 108a-108k while maintaining operational reliability under different grid conditions. For example, the power control devices 120a-120k regulate the power flow by converting DC power from the DGs 108a-108k to required voltage levels, managing power fluctuations, and ensuring stable operation under varying load conditions. The inverters may facilitate efficient energy conversion and synchronization, while the circuit breakers protect the system 100 by disconnecting faulty components. The transformers may adjust the voltage levels for efficient transmission, and the load elements may help balance demand, preventing overload and ensuring equitable power distribution among the DGs 108a-108k.

Further, in an embodiment, a structure of the cyber network 122 is mathematically represented using a Laplacian matrix L=[lᵢⱼ]_{k*k}, which defines a communication topology among the DGs 108a-108k. The elements of the Laplacian matrix represent the interconnections between the DGs 108a-108k, where:
lᵢⱼ=−aᵢⱼ, for i≠j, representing a negative weight of a cyber link (aᵢⱼ) between DGᵢ and DGⱼ, and

$${l}_{i i} = {\sum }_{n = 1 , n \neq i}^{k} {a}_{i k} ,$$

represents the total weight of all incoming connections to DGᵢ.

Additionally, a pinning matrix B is introduced to ensure that specific DGs are pinned to a nominal reference value, which enhances system stability. The pinning matrix B is defined as:

$$B = diag \{ {b}_{1} , {b}_{2} … … {b}_{k} \} , \qquad ( 16 )$$

where bᵢ>0 if DGᵢ is pinned to the nominal reference value, ensuring synchronization with external control and bᵢ=0 if DGᵢ is unpinned, relying solely on network communication for coordination.

By incorporating the Laplacian and Pinning matrices, the cyber network 122 enables efficient power distribution and fixed-time stable control, ensuring robust MG performance even in the presence of cyber disturbances or delays.

To ensure stable operation of the MG 102, the distributed control system 104 within the MG 102 is modeled as a nonlinear autonomous system defined as:

$$\dot{x} ( t ) = f ( x ( t ) ) , x ( 0 ) = {x}_{0} , \qquad ( 17 )$$

where x=[x₁, x₂, . . . x_{N}]^{T}ϵR^{N} represents system states, f(x): R^{N}→R^{N} is a continuous function with f (0)=0. The system 100 is a fixed-time stable if it satisfies Lyapunov stability conditions and converges within a finite upper-bound time Tₘₐₓ, independent of initial conditions.

Based on Lemma 1, a continuous positive definite Lyapunov function V(x) is selected, which satisfies:

$$V ( x ( t ) ) \leq {( - α V {( x ( t ) )}^{p} - β V {( x ( t ) )}^{q} )}^{k} , \qquad ( 18 )$$

where α, β, p, q, and k represents positive numbers such that pk<1 and qk>1. This ensures that the system's state converges to equilibrium within the fixed time, represented using Equation (19):

$$T \leq {T}_{max} := \frac{1}{{α}^{k} ( 1 - p k )} + \frac{1}{{β}^{k} ( q k - 1 )} \qquad ( 19 )$$

Thus, the fixed-time stability criterion ensures that the distributed control system 104 is robust to disturbances and converges within a predictable time frame, enhancing the reliability and efficiency of the MG operation.

FIG. 2 illustrates a block diagram of the secondary controller 112 of the distributed control system 104, according to certain embodiments. The secondary controller 112 is designed to optimize the allocation of power demand among the DGs 108a-108k while ensuring that the MG 102 maintains an average voltage within a predefined settling time (i.e., prescribed upper-bounded fixed settling time), even in the presence of input delays. As used herein, the term “upper-bounded fixed settling time” refers to a predetermined maximum time within which the system 100 reaches its steady state or desired operating condition, regardless of initial conditions or disturbances. In the context of the present disclosure, the upper-bounded fixed settling time means that the secondary controller 112 ensures voltage regulation and power allocation optimization among the DGs 108a-108k within a specific time frame, irrespective of input delays or system uncertainties.

An example of the operation of the secondary controller 112 may be observed in the MG 102 with multiple DGs 108a-108k, such as solar panels, wind turbines, and battery storage systems, supplying the power to a group of residential and industrial loads. Suppose the total power demand of the MG 102 fluctuates due to varying consumption patterns throughout the day. The secondary controller 112 dynamically adjusts the power contribution from each DG to achieve an optimal distribution while maintaining the MG's voltage at a desired level.

For instance, if the solar farm generates excess power during peak sunlight hours while the wind turbine produces less power due to low wind speeds, the secondary controller 112 redistributes the load by adjusting the power output of other DGs, such as batteries or fuel-based generators, to compensate the power output. At the same time, the secondary controller 112 ensures that the average voltage of the MG 102 remains within the specified range by fine-tuning the voltage reference of the primary controller 110 in each DG.

As illustrated in FIG. 2, the secondary controller 112 includes a cost optimizer 204 and a voltage regulator 206. The cost optimizer 204 operates within a fixed-time framework to equalize the ICs of the DGs 108a-108k, ensuring that the power generation is efficiently balanced among the available sources. Simultaneously, the voltage regulator 206 also operates within the fixed time framework to restore the average voltage of the MG 102 to a nominal voltage value of the MG 102. In an embodiment, cost optimization and voltage regulation functions are mathematically represented by Equations (20a) and (20b), respectively.

$${lim}_{t \to {t}_{c}} \vert {λ}_{j}^{y} - {λ}_{i}^{y} \vert = 0 , ∀ t \geq {t}_{c} , \qquad ( 20 a )$$

$${lim}_{t \to {t}_{v}} \vert \frac{1}{K} {\sum }_{i = 1}^{k} {v}_{i}^{y} - {V}_{ref} \vert = 0 , ∀ t \geq {t}_{v} , \qquad ( 20 b )$$

where t_{c} and tᵥ represent the upper-bounded fixed settling times for convergence of DGs' ICs and regulation of MG's voltage, respectively.

$${λ}_{j}^{y} , {λ}_{i}^{y}$$

represent reduced control variables associated with the ICs of j^{th} and i^{th} DGs, respectively.

$${v}_{i}^{y}$$

represents reduced control variable for the voltage of the i^{th} DG, and V_{ref} represents a reference voltage. Equation (20a) indicates that as time t approaches the upper-bounded fixed settling time t_{c}, a difference in ICs between any two DGs,

$$\vert {λ}_{j}^{y} - {λ}_{i}^{y} \vert ,$$

converges to 0. This ensures the ED, where all the DGs 108a-108k contribute optimally to power generation based on their capabilities. Similarly, Equation (20b) ensures that as time t reaches the upper-bounded fixed settling time ty, the difference between the MG's average voltage

$$\frac{1}{K} {\sum }_{i = 1}^{k} {v}_{i}^{y}$$

and the reference voltage V_{ref} approaches to zero.

In an embodiment, the secondary controller 112 may be designed to minimize the TGC of the MG 102 by optimally distributing the power demand among the available dispatchable DGs. Since each DG has different operating costs, ensuring the optimal power allocation is crucial for cost efficiency. To achieve this, the secondary controller 112 works by equalizing the ICs of all the DGs 108a-108k. The IC of the DG represents the cost of generating an additional unit of power.

To optimize cost allocation, the secondary controller 112 uses a fixed-time auxiliary control input. The fixed-time auxiliary control input is responsible for adjusting each DG's power output based on cost differences. In an exemplary embodiment, the secondary controller 112 compares an adjusted incremental cost

$$( {λ}_{j}^{y} )$$

of each DG with those of its neighboring DGs

$$( {λ}_{i}^{y} )$$

over the cyber network 122 (a digital communication network that links the DGs 108a-108k for coordination). If differences are detected, the fixed-time auxiliary control input adjusts the power contributions accordingly, ensuring that all the DGs 108a-108k reach the optimal cost level within a predetermined time frame (fixed-time convergence). The fixed-time auxiliary control input, denoted as

$${u}_{i}^{c} ,$$

is mathematically defined as follows:

$${u}_{i}^{c} = {α}_{c} {\sum }_{j ϵ {N}_{i}} {a}_{ij} {sig ( {λ}_{j}^{y} - {λ}_{i}^{y} )}^{{p}_{c}} + {β}_{c} {\sum }_{j ϵ {N}_{i}} {a}_{Mj} {sig ( {λ}_{j}^{y} - {λ}_{i}^{y} )}^{{q}_{c}} , \qquad ( 21 )$$

where α_{c}, β_{c}, p_{c}, and q_{c} represents positive control gains while p_{c}<1 and q_{c}>1. sig(·)^{θ}=|·|^{θ}sign(·) represents a nonlinear function that regulates the rate at which the ICs equalize, helping to balance the power distribution efficiently. Sign(·) represents a signum function and Nᵢ represents a set of neighboring DGs that are connected to DGᵢ through the cyber network 122, enabling communication and coordination between the DGs 108a-108k.

The effectiveness of the secondary controller 112 in equalizing the ICs among all DGs 108a-108k within the fixed-time framework is further mathematically validated by Theorem 1, where it is assumed that the cyber network graph [symbol] is connected and undirected. By employing the fully distributed fixed-time control procedure represented in Equation (21), the balance between all DGs' ICs may be effectively achieved within the predefined settling time that is independent of initial conditions.
Proof: To analyze the convergence of the ICs, an IC error may be defined using Equation (22):

$${δ}_{i}^{c} = {λ}_{i}^{y} - \frac{1}{k} {\sum }_{i = 1}^{k} {λ}_{i}^{y} , where {δ}_{i}^{c} \qquad ( 22 )$$

represents the IC error for DGᵢ. Since the cyber network 122 is undirected and connected, the term

$$\frac{1}{k} {\sum }_{i = 1}^{k} {\dot{λ}}_{i}^{y} = 0$$

remains time-invariant. Therefore, differentiating

$${δ}_{i}^{c}$$

yields

$${\dot{δ}}_{i}^{c} = {\dot{λ}}_{i}^{y} - \frac{1}{k} {\sum }_{i = 1}^{k} {\dot{λ}}_{i}^{y} = {u}_{i}^{c} \qquad ( 23 )$$

$$where {\dot{δ}}_{i}^{c}$$

represents a rate of change of the IC error for DGᵢ and

$${\dot{λ}}_{i}^{y}$$

represents a rate of change of transformed IC for DGᵢ.

By substituting the control input with Equation (21), the following expression is obtained:

$${\dot{δ}}_{i}^{c} = {α}_{c} {\sum }_{j ϵ {N}_{i}} {a}_{ij} {sig ( {δ}_{j}^{c} - {δ}_{i}^{c} )}^{{p}_{c}} + {β}_{c} {\sum }_{j ϵ {N}_{i}} {a}_{ij} {sig ( {δ}_{j}^{c} - {δ}_{i}^{c} )}^{{q}_{c}} , \qquad ( 24 )$$

Further, the following mathematical results are considered to support the fixed-time convergence of the IC balancing process. In particular, Lemma 2 and Lemma 3 provide mathematical properties that justify the fixed-time convergence result in Theorem 1.

Lemma 2: Let ξ₁, ξ₂, . . . , ξₙ≥0, where 0<ρ≤1 and σ>1, then the following inequalities hold:

$${\sum }_{i = 1}^{k} {ξ}_{i}^{μ} \geq {( {\sum }_{i = 1}^{k} {ξ}_{i} )}^{ρ} \qquad ( 25 a )$$

$${\sum }_{i = 1}^{k} {ξ}_{i}^{v} \geq {{k}^{1 - v} ( {\sum }_{i = 1}^{k} {ξ}_{l} )}^{σ} \qquad ( 25 b )$$

These inequalities establish lower bounds on the sum of power terms of state variables and are used to derive fixed-time convergence guarantees.

Lemma 3: For the undirected graph [symbol] , properties of the Laplacian matrix ( [symbol] ) include:

$${x}^{T} ℒ x = \frac{1}{2} {\sum }_{i , j = 1}^{k} {{a}_{ij} ( {x}_{j} - {x}_{i} )}^{2} , \qquad ( 26 a )$$

$${x}^{T} ℒ x \geq {Λ}_{2} ( ℒ ) {x}^{T} x , \qquad ( 26 b )$$

where x denotes a vector representing values associated with the nodes of the graph, x^{T} [symbol] represents a quadratic form of the Laplacian matrix, xⱼ-xᵢ represents value differences (e.g., ICs) between two connected nodes, Λ₂( [symbol] ) is considered as the second smallest eigenvalue of [symbol] .

Using the Lemma 2 and 3, the convergence of a Lyapunov function V₁ is analyzed as follows:

$${V}_{1} = \frac{1}{2} {δ}_{c}^{T} {δ}_{c} = \frac{1}{2} {\sum }_{i = 1}^{k} {( {δ}_{i}^{c} )}^{2} , where {δ}_{c} = {[ {δ}_{1}^{c} , {δ}_{i}^{c} , … , {δ}_{k}^{c} ]}^{T} \qquad ( 27 )$$

represents a cost mismatch vector. Therefore, a time derivative of V₁ is determined using a below Equation (28):

$$\begin{matrix}{\dot{V}}_{1} = {\sum }_{i = 1}^{k} {δ}_{i}^{c} {\dot{δ}}_{i}^{c} \\ = {\sum }_{i = 1}^{k} {δ}_{i}^{c} [ {α}_{c} {\sum }_{j ϵ {N}_{i}} {a}_{ij} {sig ( {δ}_{j}^{c} - {δ}_{i}^{c} )}^{{p}_{c}} + {β}_{c} {\sum }_{j ϵ {N}_{i}} {a}_{ij} {sig ( {δ}_{j}^{c} - {δ}_{i}^{c} )}^{{q}_{c}} ] \\ = - \frac{{α}_{c}}{2} {\sum }_{i , j = 1}^{k} {( {( {a}_{ij} )}^{\frac{2}{1 + {p}_{c}}} {\vert {δ}_{j}^{c} - {δ}_{i}^{c} \vert}^{2} )}^{\frac{1 + {p}_{c}}{2}} - \\ \frac{{β}_{c}}{2} {\sum }_{i , j = 1}^{k} {( {( {a}_{ij} )}^{\frac{2}{1 + q c}} {\vert {δ}_{j}^{c} - {δ}_{i}^{c} \vert}^{2} )}^{\frac{1 + {q}_{c}}{2}}\end{matrix} \qquad ( 28 )$$

Using Lemma 2 and Lemma 3, the following Equation (29) holds:

$${\dot{V}}_{1} \leq - {\frac{{α}_{c}}{2} [ {\sum }_{i , j = 1}^{k} {( {a}_{ij} )}^{\frac{2}{1 + {p}_{c}}} {\vert {δ}_{j}^{c} - {δ}_{i}^{c} \vert}^{2} ]}^{\frac{1 + {p}_{c}}{2}} - \frac{{β}_{c}}{2} {{k}^{\frac{1 - {q}_{c}}{2}} [ {\sum }_{i , j = 1}^{k} {( {a}_{ij} )}^{\frac{2}{1 + {q}_{c}}} {\vert {δ}_{j}^{c} - {δ}_{i}^{c} \vert}^{2} ]}^{\frac{1 + {q}_{c}}{2}} = - {\frac{{α}_{c}}{2} [ 2 {δ}_{c}^{T} ( {ℒ}^{{p}_{c}} ) {δ}_{c} ]}^{\frac{1 + {p}_{c}}{2}} - \frac{{β}_{c}}{2} {{n}^{\frac{1 - {q}_{c}}{2}} [ 2 {δ}_{c}^{T} ( {ℒ}^{{q}_{c}} ) {δ}_{c} ]}^{\frac{1 + {q}_{c}}{2}} \leq - {\frac{{α}_{c}}{2} [ 2 {Λ}_{2} ( {ℒ}^{{p}_{c}} ) {δ}_{c}^{T} {δ}_{c} ]}^{\frac{1 + {p}_{c}}{2}} - \frac{{β}_{c}}{2} {{k}^{\frac{1 - {q}_{c}}{2}} [ 2 {Λ}_{2} ( {ℒ}^{{q}_{c}} ) {δ}_{c}^{T} {δ}_{c} ]}^{\frac{1 + {q}_{c}}{2}} \leq - {\frac{{α}_{c}}{2} [ 4 {Λ}_{2} ( {ℒ}^{{p}_{c}} ) {V}_{1} ]}^{\frac{1 + {p}_{c}}{2}} - \frac{{β}_{c}}{2} {{k}^{\frac{1 - q c}{2}} [ 4 {Λ}_{2} ( {ℒ}^{{q}_{c}} ) {V}_{1} ]}^{\frac{1 + q c}{2}} \qquad ( 29 )$$

where [symbol] indicates the Laplacian matrix having an adjacency matrix

$${𝒜}^{{p}_{c}} = [ {( {a}_{ij} )}^{\frac{2}{1 + {p}_{c}}} ] ,$$

and [symbol] is the Laplacian matrix with an adjacency matrix

$${𝒜}^{{q}_{c}} = [ {( {a}_{ij} )}^{\frac{2}{1 + {q}_{c}}} ] . Let {K}_{1} = {\frac{{α}_{c}}{2} [ 4 {Λ}_{2} ( {ℒ}^{{p}_{c}} ) ]}^{\frac{1 + {p}_{c}}{2}} , and {K}_{2} = \frac{{β}_{c}}{2} {{k}^{\frac{1 - {q}_{c}}{2}} [ 4 {Λ}_{2} ( {ℒ}^{{q}_{c}} ) ]}^{\frac{1 + {q}_{c}}{2}} .$$

Then the following Equation (30) is obtained:

$${\dot{V}}_{1} \leq - {{K}_{1} ( {V}_{1} )}^{\frac{1 + {p}_{c}}{2}} - {{K}_{2} ( {V}_{1} )}^{\frac{1 + {q}_{c}}{2}} \qquad ( 30 )$$

According to Lemma 1, V₁→0 within an upper bounded fixed settling time, t_{c}, where

$${t}_{c} \leq \frac{2}{{\frac{{α}_{c}}{2} [ 4 {Λ}_{2} ( {ℒ}^{{p}_{c}} ) ]}^{\frac{1 + {p}_{c}}{2}} ( 1 - {p}_{c} )} + \frac{2}{\frac{{β}_{c}}{2} {{k}^{\frac{1 - {q}_{c}}{2}} [ 4 {Λ}_{2} ( {ℒ}^{{q}_{c}} ) ]}^{\frac{1 + {q}_{c}}{2}} ( {q}_{c} - 1 )} \qquad ( 31 )$$

Thus, within the fixed time t_{c}, the IC mismatch converges to zero, ensuring

$${λ}_{j}^{y} = {λ}_{i}^{y} , ∀ i , j .$$

This establishes the proof of Theorem 1.

The IC balancing process respects the inequality constraints imposed on each DG to ensure practical feasibility. Specifically, when the DG reaches its maximum or minimum power capacity, it no longer adjusts its IC to achieve an economic operating point as described in Equation (9). Instead, the DG operates at a constraint limit while maintaining system stability. To address this, the cost auxiliary control is updated to enforce the IC balancing at a violated power limit, ensuring smooth operation within the fixed-time convergence. The modified control laws are as follows:

For lower limit constraint: If the DG reaches its minimum operating limit λᵢ, the control input is adjusted as follows:

$${u}_{i}^{c} = {α}_{c} {\sum }_{j ϵ {N}_{i}} {a}_{ij} s i {g ( \underline{{λ}_{i}} - {λ}_{i}^{y} )}^{{p}_{c}} + {β}_{c} {\sum }_{j ϵ {N}_{i}} {a}_{ij} {sig ( \underline{{λ}_{i}} - {λ}_{i}^{y} )}^{{q}_{c}} \qquad ( 32 )$$

Equation (32) ensures that

$${λ}_{i}^{y}$$

remains at λᵢ, when the lower limit constraint is active.

For upper limit constraint: If the DG reaches its maximum operating limit λ̅ᵢ̅, the control input is updated as follows:

$${u}_{i}^{c} = {α}_{c} {\sum }_{j ϵ {N}_{i}} {a}_{ij} {sig ( \overline{{λ}_{i}} - {λ}_{i}^{y} )}^{{p}_{c}} + {β}_{c} {\sum }_{j ϵ {N}_{i}} {a}_{ij} {sig ( \overline{{λ}_{i}} - {λ}_{i}^{y} )}^{{q}_{c}} \qquad ( 33 )$$

Equation (33) prevents

$${λ}_{i}^{y}$$

from exceeding λ̅ᵢ̅, ensuring that the DG remains within its permissible range.

In an embodiment, the secondary controller 112 is configured to perform fixed-time consensus-based voltage estimation for distributed restoration of the MG's average voltage. The secondary controller 112 enables the DG to estimate the MG's average voltage using the voltage states of its nearest neighboring DGs, ensuring a decentralized and efficient restoration process. Unlike conventional methods that rely on centralized control, the disclosed approach achieves estimation within the predefined settling time, independent of initial voltage values. To achieve this, the secondary controller 112 implements the fixed-time consensus-based voltage observer, represented using Equation (34):

$${\hat{v}}_{i} = {v}_{i} + \int ( α {\sum }_{j ϵ {N}_{i}} {a}_{ij} {sig ( {\hat{v}}_{j} - {\hat{v}}_{i} )}^{p} + β {\sum }_{j ϵ {N}_{i}} {a}_{ij} {sig ( {\hat{v}}_{j} - {\hat{v}}_{i} )}^{q} ) dt , \qquad ( 34 )$$

where vᵢ represents the measured voltage at DGᵢ. \hat{v}ᵢ represents estimated MG's average voltage. The secondary controller 112 utilizes adjacency weights aᵢⱼ to facilitate communication between the neighboring DGs while the control factors are α, β>0, 0<p<1, and q>1.

Consider an x MG consisting of multiple DGs operating in a decentralized manner. Due to disturbances, such as load changes or faults, the voltage across the x MG deviates from its nominal value, necessitating restoration to maintain system stability. In an embodiment, the secondary controller 112 in each DG is configured to estimate the x MG's average voltage in a fixed-time manner. Each DG does not require information from the central controller but relies solely on voltage data from its nearest neighboring DGs.

For instance, assume the x MG with three DGs (DG₁, DG₂, and DG₃). DG₁ has an initial voltage of 1.02 pu, DG₂ has an initial voltage of 0.98 pu, DG₃ has an initial voltage of 1.05 pu. The secondary controller 112 at each DG estimates the average voltage using the fixed-time consensus algorithm, represented in Equation (34). Each DG exchanges its voltage data with its immediate neighbors: DG₁ communicates with DG₂, DG₂ communicates with both DG₁ and DG₃ and DG₃ communicates with DG₂. Using the fixed-time consensus algorithm, each DG dynamically adjusts its estimated voltage ît based on the voltage differences with its neighbors. The estimation converges within the predefined fixed time, say T=2s, regardless of initial conditions. After T=2s, all DGs reach an estimated average voltage of 1.016 pu, allowing for accurate and decentralized voltage restoration across the x MG.

Furthermore, in an embodiment, the secondary controller 112 is configured to implement a fully distributed fixed-time voltage regulator 206 to restore the MG's voltage within a predetermined convergence time, independent of the initial voltage values. In this approach, each DG utilizes its locally estimated value and the values from its neighboring DGs, ensuring a cooperative restoration process. At least one DG, referred to as a pinned (dominant) DG, has access to the desired reference voltage value. The controller of these pinned DGs compares their estimated voltage with both the neighboring DGs' estimated values and the MG's reference voltage, as represented by:

$${u}_{i}^{v} = {α}_{v} [ {\sum }_{j ϵ {N}_{i}} {a}_{ij} {sig ( {\hat{v}}_{j}^{y} - {\hat{v}}_{i}^{y} )}^{{p}_{v}} + {b}_{i} {sig ( {V}_{ref} - {\hat{v}}_{i}^{y} )}^{{p}_{v}} ] + {β}_{v} [ {\sum }_{j ϵ {N}_{i}} {a}_{ij} {sig ( {\hat{v}}_{j}^{y} - {\hat{v}}_{i}^{y} )}^{{q}_{v}} + {b}_{i} {sig ( {V}_{ref} - {\hat{v}}_{i}^{y} )}^{{q}_{v}} ] , \qquad ( 35 )$$

where αᵥ, βᵥ, pᵥ, and qᵥ are positive control gains while p_{V}<1 and qᵥ>1. bᵢ represents a pinning gain of the dominant DGs and bᵢ>0 only if DGᵢ accesses the desired nominal value; otherwise bᵢ=0. The secondary controller 112 dynamically adjusts uᵢ^{v} based on real-time voltage discrepancies, ensuring robust and stable voltage restoration across the MG 102.

Consider a microgrid (MG) with four distributed generators (DG₁, DG₂, DG₃, and DG₄). Due to disturbances, such as sudden changes in load demand, the voltage levels at each DG deviate from the nominal value. The goal of the secondary controller 112 is to restore the MG's voltage to the reference voltage of V_{ref}=1.0 pu within the predefined settling time, ensuring stability and reliability.

In this scenario, DG₁ is designated as the pinned (dominant) DG, meaning it has direct access to the reference voltage. The other DGs (DG₂, DG₃, and DG₄) estimate the average voltage based on their values and values received from their nearest neighbors. Assume that before regulation, the initial voltages of the DGs are as follows: DG₁=1.0 pu, DG₂=0.95 pu, DG₃=1.02 pu, and DG₄=0.97 pu. Using the fully distributed fixed-time voltage regulator 206, each DG dynamically adjusts its voltage control input

$${u}_{i}^{v}$$

based on Equation (33).

DG₁, having direct access to V_{ref}, compares its voltage with the estimated values from neighboring DGs and maintains stability. The other DGs, such as DG₂, DG₃, and DG₄, adjust their control inputs based on the discrepancy between their estimated voltage and the reference voltage, as well as the voltage differences with their immediate neighbors.

As a result, all DGs reach the reference voltage V_{ref}=1.0 pu within the predefined fixed-time convergence, say T=3s, regardless of their initial voltage values. This cooperative approach ensures a fully distributed and robust voltage regulation mechanism, eliminating the need for centralized control while guaranteeing efficient microgrid stability.

The effectiveness of the secondary controller 112 in ensuring the fixed-time voltage restoration for the MG 102 is mathematically validated by Theorem 2. Theorem 2 establishes that under the assumption that the cyber graph [symbol] is connected and undirected, the proposed fully distributed fixed-time controller guarantees the restoration of the MG's average voltage within a fixed time.

To prove this, let a local voltage restoration error be defined as

$${δ}_{i}^{v} = {\hat{v}}_{i}^{y} - {V}_{ref} , where {\hat{v}}_{i}^{y}$$

represents the estimated voltage at the i^{th} DG, and V_{ref} is the desired reference voltage. Differentiating

$${δ}_{i}^{v}$$

with respect to time yields the following expression:

$${\dot{δ}}_{i}^{v} = {u}_{i}^{v} , \qquad ( 36 )$$

By substituting the fully distributed fixed-time voltage controller in Equation (36):

$${\dot{δ}}_{i}^{v} = {α}_{v} [ {\sum }_{j ϵ {N}_{i}} {a}_{ij} {sig ( {δ}_{j}^{v} - {δ}_{i}^{v} )}^{{p}_{v}} - {b}_{i} {sig ( {δ}_{i}^{v} )}^{{p}_{v}} ] + {β}_{v} [ {\sum }_{j ϵ {N}_{i}} {a}_{ij} {sjg ( {δ}_{j}^{v} - {δ}_{i}^{v} )}^{{q}_{v}} - {b}_{i} {sjg ( {δ}_{i}^{v} )}^{{q}_{v}} ] \qquad ( 37 )$$

Following the proof of Theorem 2, the fixed-time convergence of the MG's voltage restoration may be further established using Lyapunov analysis. Lemma 4 provides key insights into the properties of the Laplacian matrix [symbol] and the pinning matrix [symbol] for the undirected graph with a reference link. Specifically, a sum-of-squares representation of the Laplacian and pinning matrices ensures that the smallest eigenvalue Λ₂( [symbol] + [symbol] ) provides a lower bound on the quadratic form x^{T}( [symbol] + [symbol] )x, ensuring system stability.

Mathematically, for the undirected graph [symbol] with a pinning link to receive the reference, the Laplacian matrix ( [symbol] + [symbol] ) satisfies the following sum-of-squares representation:

$${x}^{T} ( ℒ + ℬ ) x = \frac{1}{2} {\sum }_{i , j = 1}^{k} {{a}_{ij} ( {x}_{j} - {x}_{i} )}^{2} + {\sum }_{i = 1}^{N} {{b}_{i} ( {x}_{i} )}^{2} \qquad ( 38 )$$

Furthermore, the smallest eigenvalue Λ₂( [symbol] + [symbol] ) provides a lower bound on the quadratic form, ensuring that:

$${x}^{T} ( ℒ + ℬ ) x \geq {Λ}_{2} ( ℒ + ℬ ) {x}^{T} x \qquad ( 39 )$$

Equation (39) ensures that any deviation in the voltage states across the MG 102 is constrained by spectral properties of the Laplacian and pinning matrices. Since Λ₂( [symbol] + [symbol] ) is positive for the connected graph with at least one pinned node, the system 100 remains stable and converges to the desired voltage level.

Further, the Lyapunov function is defined as:

$${V}_{2} = \frac{1}{2} {δ}_{v}^{T} {δ}_{v} = \frac{1}{2} {\sum }_{i = 1}^{n} {δ}_{i}^{{v}^{2}} where {δ}_{v} = {[ {δ}_{1}^{v} , {δ}_{i}^{v} , … , {δ}_{k}^{v} ]}^{T} \qquad ( 40 )$$

represents a disagreement vector in the MG's voltage states. Differentiating V₂ along the system dynamic yields:

$${\dot{V}}_{2} = {\sum }_{i = 1}^{n} {δ}_{i}^{v} {\dot{δ}}_{i}^{v} = {\sum }_{i = 1}^{n} {δ}_{i}^{v} [ {α}_{v} ( {\sum }_{j ϵ {N}_{i}} {a}_{ij} {sig ( {δ}_{j}^{v} - {δ}_{i}^{v} )}^{{p}_{v}} - {b}_{i} {sig ( {δ}_{i}^{v} )}^{{p}_{v}} ) + {β}_{v} ( {\sum }_{j ϵ {N}_{i}} {a}_{ij} {sig ( {δ}_{j}^{v} - {δ}_{i}^{v} )}^{{q}_{v}} - {b}_{i} {sig ( {δ}_{i}^{v} )}^{{q}_{v}} ) ] = - \frac{{α}_{v}}{2} [ {\sum }_{i , j = 1}^{k} {( {( {a}_{ij} )}^{\frac{2}{1 + {p}_{v}}} {\vert {δ}_{j}^{v} - {δ}_{i}^{v} \vert}^{2} )}^{\frac{1 + {p}_{v}}{2}} + 2 {\sum }_{i = 1}^{k} {( {( {b}_{i} )}^{\frac{2}{1 + {p}_{v}}} {\vert {δ}_{i}^{v} \vert}^{2} )}^{\frac{1 + {p}_{v}}{2}} ] - \frac{{β}_{v}}{2} [ {\sum }_{i , j = 1}^{k} {( {( {a}_{ij} )}^{\frac{2}{1 + {q}_{v}}} {\vert {δ}_{j}^{v} - {δ}_{i}^{v} \vert}^{2} )}^{\frac{1 + {q}_{v}}{2}} + 2 {\sum }_{i = 1}^{k} {( {( {b}_{i} )}^{\frac{2}{1 + {q}_{v}}} {\vert {δ}_{i}^{v} \vert}^{2} )}^{\frac{1 + {q}_{v}}{2}} ] \qquad ( 41 )$$

$$Let Γ ( {δ}_{v}^{{p}_{v}} ) = \frac{{α}_{v}}{2} [ {\sum }_{i , j = 1}^{k} {( {( {a}_{ij} )}^{\frac{2}{1 + {p}_{v}}} {\vert {δ}_{j}^{v} - {δ}_{i}^{v} \vert}^{2} )}^{\frac{1 + {p}_{v}}{2}} + 2 {\sum }_{i = 1}^{k} {( {( {b}_{i} )}^{\frac{2}{1 + {p}_{v}}} {\vert {δ}_{i}^{v} \vert}^{2} )}^{\frac{1 + {p}_{v}}{2}} ] .$$

Based on Lemma 2 and Lemma 4, the following inequality holds:

$$Γ ( {δ}_{v}^{{p}_{v}} ) \geq {\frac{{α}_{v}}{2} [ {\sum }_{i , j = 1}^{n} {( {a}_{ij} )}^{\frac{2}{1 + {p}_{v}}} {\vert {δ}_{j}^{v} - {δ}_{i}^{v} \vert}^{2} + 2 {\sum }_{i = 1}^{n} {( {b}_{i} )}^{\frac{2}{1 + {p}_{v}}} {\vert {δ}_{i}^{v} \vert}^{2} ]}^{\frac{1 + {p}_{v}}{2}} = {\frac{{α}_{v}}{2} [ 2 {δ}_{v}^{T} ( {ℒ}^{{p}_{v}} + {ℬ}^{{p}_{v}} ) {δ}_{v} ]}^{\frac{1 + {p}_{v}}{2}} \geq {\frac{{α}_{v}}{2} [ 2 {Λ}_{2} ( {ℒ}^{{p}_{v}} + {ℬ}^{{p}_{v}} ) {δ}_{M}^{T} {δ}_{M} ]}^{\frac{1 + {p}_{v}}{2}} = {\frac{{α}_{v}}{2} [ 2 {Λ}_{2} ( {ℒ}^{{p}_{v}} + {ℬ}^{{p}_{v}} ) {V}_{2} ]}^{\frac{1 + {p}_{v}}{2}}$$

$$where {ℬ}^{P v} = diag \{ {( {b}_{i} )}^{\frac{2}{1 + {p}_{v}}} \}$$

signifies the voltage pinning matrix.

Further, by defining

$$Γ ( {δ}_{v}^{{q}_{v}} )$$

as follows,

$$Γ ( {δ}_{v}^{{q}_{v}} ) = \frac{{β}_{v}}{2} [ {\sum }_{i , j = 1}^{k} {( {( {a}_{ij} )}^{\frac{2}{1 + {q}_{v}}} {\vert {δ}_{j}^{v} - {δ}_{i}^{v} \vert}^{2} )}^{\frac{1 + {q}_{v}}{2}} + 2 {\sum }_{i = 1}^{k} {( {( {b}_{i} )}^{\frac{2}{1 + {q}_{v}}} {\vert {δ}_{i}^{v} \vert}^{2} )}^{\frac{1 + {q}_{v}}{2}} ] ,$$

Equation (43) can be obtained as:

$$Γ ( {δ}_{v}^{{q}_{v}} ) \geq \frac{{β}_{v}}{2} {{k}^{\frac{1 - {q}_{v}}{2}} [ 2 {Λ}_{2} ( {ℒ}^{{q}_{v}} + {ℬ}^{{q}_{v}} ) {V}_{2} ]}^{\frac{1 + {q}_{v}}{2}} \qquad ( 43 )$$

where [symbol] indicates the voltage pinning matrix with the i^{th} diagonal element

$${( {b}_{i} )}^{\frac{2}{1 + {q}_{v}}} .$$

By combining Equation (42) and Equation (43), the time derivative of V₂ is obtained using Equation (44):

$${\dot{V}}_{2} \leq - {{\frac{{α}_{v}}{2} [ 2 {Λ}_{2} ( {ℒ}^{{p}_{v}} + {ℬ}^{{p}_{v}} ) ]}^{\frac{{p}_{v} + 1}{2}} [ {V}_{2} ]}^{\frac{1 + {p}_{v}}{2}} - \frac{{β}_{v}}{2} {{{k}^{\frac{1 - q}{2}} [ 2 {Λ}_{2} ( {ℒ}^{{q}_{v}} + {ℬ}^{{q}_{v}} ) ]}^{\frac{1 + {q}_{v}}{2}} [ {V}_{2} ]}^{\frac{1 + {q}_{v}}{2}} \qquad ( 44 )$$

$$Let {K}_{3} = {\frac{{α}_{v}}{2} [ 2 {Λ}_{2} ( {ℒ}^{{p}_{v}} + {ℬ}^{{p}_{v}} ) ]}^{\frac{1 + {p}_{v}}{2}} , {K}_{4} = \frac{{β}_{v}}{2} {{k}^{\frac{1 - {q}_{v}}{2}} [ 2 {Λ}_{2} ( {ℒ}^{{q}_{v}} + {ℬ}^{{q}_{v}} ) ]}^{\frac{1 + {q}_{v}}{2}} ,$$

then the following Equation (45) is obtained.

$${\dot{V}}_{2} \leq - {{K}_{3} ( {V}_{2} )}^{\frac{1 + {p}_{v}}{2}} - {{K}_{4} ( {V}_{2} )}^{\frac{1 + {q}_{v}}{2}} \qquad ( 45 )$$

Therefore, according to Lemma 1, the MG's average voltage reaches the desired value within a fixed time bounded by:

$${t}_{v} \leq \frac{2}{{\frac{{α}_{v}}{2} [ 2 {Λ}_{2} ( {ℒ}^{{p}_{v}} + {ℬ}^{{p}_{v}} ) ]}^{\frac{1 + {p}_{v}}{2}} ( 1 - {p}_{v} )} + \frac{2}{\frac{{β}_{v}}{2} {{k}^{\frac{1 - {q}_{v}}{2}} [ 2 {Λ}_{2} ( {ℒ}^{{p}_{v}} + {ℬ}^{{p}_{v}} ) ]}^{\frac{1 + {q}_{v}}{2}} ( {q}_{v} - 1 )} \qquad ( 46 )$$

This establishes the proof of Theorem 2. Consequently, the upper bound on the settling time for achieving agreement in the ICs of the DGs 108a-108k and the regulation of the average voltage is given by:

$$t = max \{ {t}_{λ} , {t}_{v} \} + max \{ {h}_{i} \} \qquad ( 47 )$$

where the upper bound is determined solely by controller parameters, a cyber-physical network structure, and associated time delays.

Referring to FIG. 2, a control framework for the MG 102 is illustrated, demonstrating interaction between components of the secondary controller 112 to achieve the optimal power distribution and voltage regulation while accounting for cyber network delays. The process begins with neighboring data exchange 200, where each DG communicates with its two nearest neighboring DGs through the cyber links 124a-124k. This allows distributed decision-making and real-time system updates. However, the cyber links 124a-124k introduce time delays in the cyber network 122, which are mitigated using Artstein transformation 202. The Artstein transformation 202 suppresses the effect of the time delays in the cyber network 122, ensuring that the control strategy remains stable despite inherent communication lags.

Following this, the secondary controller 112 employs the cost optimizer 204, which determines the optimal power allocation by equalizing the ICs of all the DGs 108a-108k. The cost optimizer 204 calculates an adjustment term based on IC differences among the DGs 108a-108k and generates an output control signal

$$( {u}_{i}^{c} ) S 208$$

as defined in Equation (21). The control signal

$$( {u}_{i}^{c} ) S 208$$

is processed through a term

$$\frac{{r}_{i}}{2 {γ}_{i}} 216$$

before being used in a control loop.

Simultaneously, the voltage regulator 206 works to restore the average MG voltage to the nominal value by comparing the estimated voltage of each DG with both the neighboring DGs' estimated values and the MG's reference voltage. The output of the voltage regulator 206 is denoted as

$${u}_{i}^{v} ,$$

which is obtained as the sum or two components C1 210 and C2 212 in a first summation block 214, represented as:

$${u}_{i}^{v} = C 1 + C 2 where : \qquad ( 48 )$$

$$C 1 = α [ {\sum }_{j ϵ {N}_{i}} {a}_{ij} {sig ( {\hat{v}}_{j}^{y} - {\hat{v}}_{i}^{y} )}^{p} + {b}_{i} {sig ( {V}_{ref} - {\hat{v}}_{i}^{y} )}^{p} ] \qquad ( 49 )$$

$$C 2 = β [ {\sum }_{j ϵ {N}_{i}} {a}_{ij} {sig ( {\hat{v}}_{j}^{y} - {\hat{v}}_{i}^{y} )}^{q} + {b}_{i} {sig ( {V}_{ref} - {\hat{v}}_{i}^{y} )}^{q} ] \qquad ( 50 )$$

The outputs from both the cost optimizer 204 and the voltage regulator 206 are then summed together in a second summation block 218. The combined control signal is passed through an integrator 220, which smooths out the control response before being processed through a delay compensation module 222. The output of this integration is the nominal voltage reference

$$( {v}_{i}^{n o m} ) ,$$

which represents the voltage setpoint that each DG should follow for optimal operation.

Once nominal voltage reference

$$( {v}_{i}^{n o m} )$$

is obtained, it is passed through the delay compensation module 222 to account for communication delays in the cyber network 122. The communication delays may arise due to data transmission lags between the DGs 108a-108k, affecting real-time coordination. The Artstein transformation 202 is applied at this stage to mitigate the impact of time delays, ensuring that the control signals remain synchronized and effective. Further, the output

$${u}_{i}^{v}$$

from the voltage regulator 206 and the processed signal from the cost optimizer 204 are passed separately into a third summation block 224. Here, the voltage regulation signal

$${u}_{i}^{v}$$

is added to the delayed voltage reference signal while the processed

$$( {v}_{i}^{n o m} )$$

while the processed cost optimization term (rᵢ) 226 is subtracted before passing a final control signal to a voltage and current control loop 228. The voltage control loop fine-tunes the output voltage, while the current control loop ensures that the DGs 108a-108k share power proportionally and maintain current stability.

The controlled voltage and current signals are then processed by a Pulse Width Modulation (PWM) controller 230, which generates precise switching signals for power electronic converters in DGᵢ 232. The DGᵢ 232 regulates their power output accordingly and supplies the output power to the MG DC Bus 234, which efficiently distributes the power across MGs.

Tables 1A and 1B represent a comparison of various existing control strategies alongside the distributed control system 104. The comparison spans multiple key objectives, such as fully distributed control, fixed settling time, rapid convergence, economic operation, equality constraint, management of DG's capacity limits, cyber delays, and so forth. A range of features, including plug-n-play capability and link-failure resiliency, are also considered for comparison. The existing control strategies developed by researchers such as Wang et al., Moayedi et al., Hu et al., and others, are evaluated based on these objectives and features. The existing control strategies primarily emphasize achieving economic operation, enforcing equality constraints, and handling DG's capacity limits, with some also addressing the impact of the cyber delays.

TABLE 1
Conventional control strategies

| | | | | J, | | | | D, | |
|---|---|---|---|---|---|---|---|---|---|
| | | | S, | Hu | Han, | A, | A, | Liu | |
| | | Wang, | Moayedi | et | H et | Hamad, | Hamad | et | Z, Lv et |
| Perceptions | Items | Z et al. | et al. | al. | al. | et al. | et al. | al. | al. |
| Main | Fully | √ | √ | √ | √ | √ | √ | √ | √ |
| objectives | distributed | | | | | | | | |
| | control | | | | | | | | |
| | Fixed settling | | | | | | | | |
| | time | | | | | | | | |
| | Rapid | | | | | | | | |
| | convergence | | | | | | | | |
| | Economic | √ | √ | √ | √ | √ | √ | √ | √ |
| | operation | | | | | | | | |
| | Equality | √ | √ | √ | √ | √ | √ | √ | √ |
| | constraint | | | | | | | | |
| | DG's | √ | √ | | | √ | √ | √ | |
| | capacity | | | | | | | | |
| | limits | | | | | | | | |
| | Cyber delays | | | | √ | | | | |
| Features | Plug-n-Play | √ | √ | √ | | | | | √ |
| | capability | | | | | | | | |
| | Link-failure | √ | √ | √ | | | | | |
| | resiliency | | | | | | | | |
| | | Y | | | | | | | |
| | | Dou | G, | M, | Martinez | Z, | M, | Y, | Distributed |
| | | et | Chen | Zaery | Gomez | Cheng | Zaery | Feng | control system |
| Perceptions | Items | al. | et al. | et al. | et al. | et al. | et al. | et al. | 104 |
| Main | Fully | √ | √ | √ | √ | √ | √ | √ | √ |
| objectives | distributed | | | | | | | | |
| | control | | | | | | | | |
| | Fixed | | | | √ | √ | √ | √ | √ |
| | settling time | | | | | | | | |
| | Rapid | | √ | √ | √ | √ | √ | √ | √ |
| | convergence | | | | | | | | |
| | Economic | √ | √ | √ | √ | √ | √ | | √ |
| | operation | | | | | | | | |
| | Equality | √ | √ | √ | | √ | √ | √ | √ |
| | constraint | | | | | | | | |
| | DG's | √ | √ | √ | | √ | | | √ |
| | capacity | | | | | | | | |
| | limits | | | | | | | | |
| | Cyber | | | | | | | √ | √ |
| | delays | | | | | | | | |
| Features | Plug-n-Play | | | √ | √ | √ | √ | √ | √ |
| | capability | | | | | | | | |
| | Link-failure | | | √ | | | | | √ |
| | resiliency | | | | | | | | |

In comparison, the distributed control system 104 aims to enhance the existing control strategies by focusing on critical areas like fixed settling time, rapid convergence, and improved handling of DG's capacity limits. The distributed control system 104 integrates advanced features such as the plug-n-play capability and link-failure resiliency while also considering the challenges posed by the cyber delays. This comparison indicates how the distributed control system 104 builds on existing methodologies, aiming for improved performance and adaptability in the management of MGs.

Table 2 represents parameters of the MG 102, which includes four DGs and is simulated using a piecewise linear electrical circuit simulation (PLECS) platform to demonstrate the effectiveness of the distributed control system 104. The parameters include DGs' generation costs, transmission line parameters, and secondary controller parameters. The DG's generation costs include fixed cost (c( [symbol] )), linear cost coefficient (b( [symbol] /W)), quadric cost coefficient (a( [symbol] /W²)), minimum

$$( {P}_{i}^{m i n} )$$

and maximum

$$( {P}_{i}^{m ax} )$$

power generation limits.

The transmission line parameters include resistance (R), capacitance (C) and inductance (L) of the network 106. The transmission line parameters influence electrical characteristics of power transmission across the MG 102. The secondary controller parameters include cost optimization parameters α_{c}, β_{c}, p_{c}, q_{c}, which are set to 1, 1, 0.6, and 1.4, respectively, to regulate a cost optimization behavior of the system 100, voltage regulation parameters αᵥ, βᵥ, pᵥ, qᵥ, which are assigned the same values (1, 1, 0.6, and 1.4) to influence voltage regulation dynamics, resistance parameters (r₁, r₂, r₃, r₄) which are set to 0.5 for all the DGs, ensuring uniform resistance settings within a secondary control loop, time delay parameters (h₁, h₂, h₃, h₄), which represent communication and control delays. These delays vary across the DGs, with values ranging from 40 milliseconds (ms) to 60 ms, directly affecting the overall response time and stability of the MG 102. Further, the cyber network 122 of the MG 102 is characterized by an adjacency matrix [symbol] =[0,1,0,1; 1,0,1,0; 0,1,0,1; 1,0,1,0] indicating that each DG is connected to two neighboring DGs in a ring topology. Furthermore, only DG₁ receives the MG's voltage reference, as indicated by a diagonal pinning matrix [symbol] =diag {1,0,0,0}, ensuring hierarchical control within a decentralized structure. This parameter set enables accurate modeling of the MG 102, facilitating a validation of the distributed control system 104.

TABLE 2
Parameters of the modeled DC MG
DGs generation costs

| DG | c ( [symbol] ) | b ( [symbol] /W) | a ( [symbol] /W²) | Pᵢ^{max} | Pᵢ^{min} |
|---|---|---|---|---|---|
| DG₁ | 95 | 0.64 | 0.013 | 350 | 55 |
| DG₂ | 75 | 0.59 | 0.008 | 230 | 40 |
| DG₃ | 85 | 0.62 | 0.011 | 450 | 65 |
| DG₄ | 80 | 0.60 | 0.009 | 500 | 85 |

Transmission lines parameters

| parameter | R | L | C |
|---|---|---|---|
| Value | 0.5 Ω | 50 μH | 30 nF |

Secondary controller parameters

| α_{c} | β_{c} | p_{c} | q_{c} |
|---|---|---|---|
| 1 | 1 | 0.6 | 1.4 |

| αᵥ | βᵥ | pᵥ | qᵥ |
|---|---|---|---|
| 1 | 1 | 0.6 | 1.4 |
| r₁ | r₂ | r₃ | r₄ |
| 0.5 | 0.5 | 0.5 | 0.5 |

| h₁ | h₃ | h₃ | h₄ |
|---|---|---|---|
| 50 ms | 40 ms | 60 ms | 50 ms |

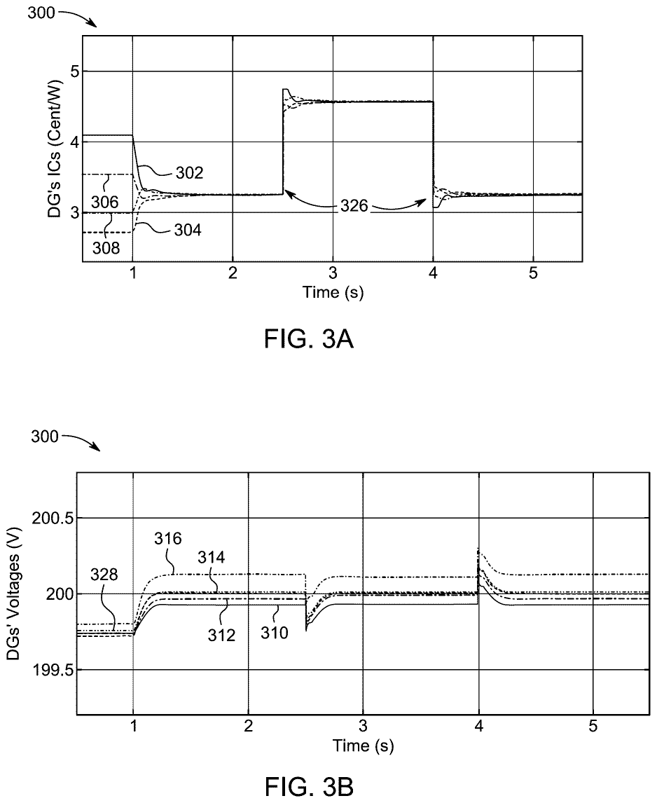

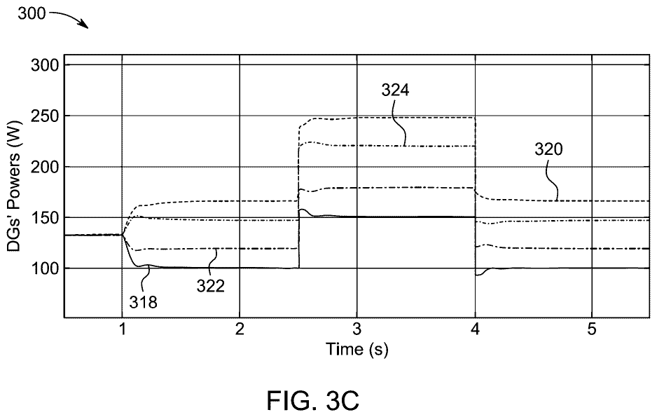

FIGS. 3A-3B illustrate graphical representations 300 of operation of the distributed control system 104 under variable load conditions, according to certain embodiments. The operation of the distributed control system 104 demonstrates its ability to optimize the ED while maintaining the voltage stability. In FIG. 3A, ICs λ₁ 302, λ₂ 304, λ₃ 306, λ₄ 308 of the DGs 108a-108k are shown, representing a cost per unit of power generated by each DG. Initially, for t<1s, the droop controller 114 is active, distributing the power based on predefined droop coefficients (rᵢ=0.5), leading to a reduction in the MG's average voltage. At t=1s, the secondary controller 112 is activated, ensuring that the ICs λ₁ 302, λ₂ 304, λ₃ 306, λ₄ 308 of all the DGs 108a-108k converge to an optimal value within the fixed settling time, thereby achieving an economic power distribution that minimizes the TGC. Additionally, when load changes 326 occur, the secondary controller 112 readjusts the power distribution among the DGs 108a-108k to maintain the system stability, voltage regulation, and optimal power-sharing.

FIG. 3B depicts voltage responses V₁ 310, V₂ 312, V₃ 314, V₄ 316 of the individual DGs 108a-108k and an average MG voltage (V_{avg}) 328. Initially, the activation of the droop controller 114 causes a voltage drop. However, once the secondary controller 112 is enabled, the average MG voltage (V_{avg}) 328 is restored to its nominal value, ensuring the power balance between the generation and the demand. As the load changes, the secondary controller 112 successfully regulates the voltage levels V₁ 310, V₂ 312, V₃ 314, V₄ 316 of all the DGs 108a-108k within a fixed time, maintaining stable operation.

FIG. 3C depicts power outputs P₁ 318, P₂ 320, P₃ 322, P₄ 324 of the DGs 108a-108k, indicating the ED process. Before the secondary controller 112 activation, the DGs 108a-108k share the load based on the mechanism of the droop controller 114. Once the secondary controller 112 is enabled at t=1s, the power outputs P₁ 318, P₂ 320, P₃ 322, P₄ 324 are adjusted optimally to minimize costs while meeting the demand. During load increase events, the secondary controller 112 dynamically redistributes the power among the DGs 108a-108k to accommodate the additional demand, while in load reduction scenarios, the DG's outputs are rescheduled to their initial optimal values. The system 100 maintains stable voltage and cost-effective power generation despite the load changes, demonstrating the effectiveness of the distributed control system 104 in the MG 102.

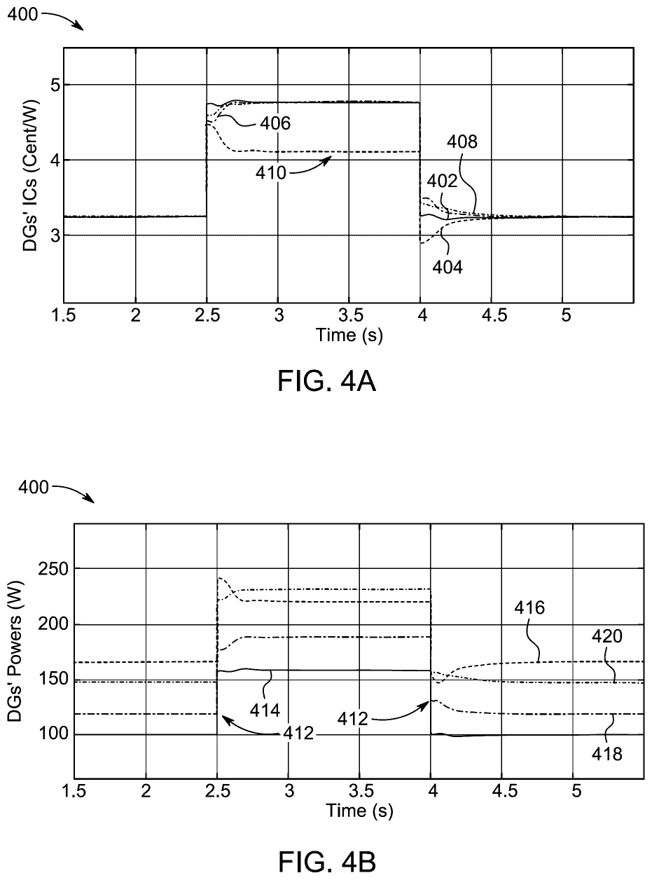

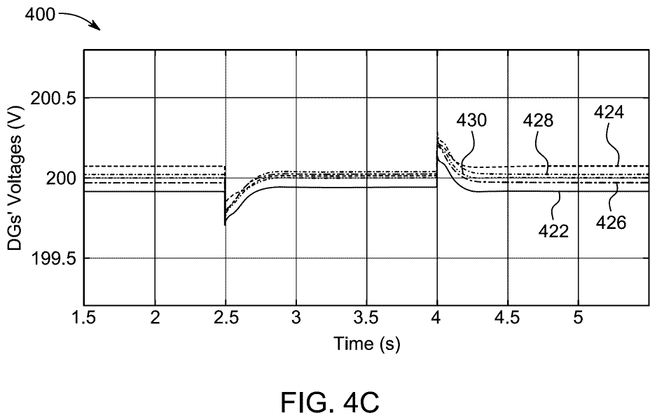

FIGS. 4A-4C illustrate graphical representations 400 of performance of the distributed control system 104 while considering the DG's capacity limits, according to certain embodiments. Initially, for t<2.5s, the distributed control system 104 ensures that all DGs 108a-108k operate at their optimal power levels by equalizing their ICs (λ₁ 402, λ₂ 404, λ₃ 406, λ₄ 408) as shown in FIG. 4A. At t=2.5s, a load increase occurs, requiring a redistribution of the power among the DGs 108a-108k to meet a new demand while maintaining the power balance between the generation and consumption. Also, as depicted in FIG. 4B, P₂ 416 reaches its maximum limit and is constrained to 230 watts (W). Consequently, λ₂ 404 is constrained at its maximum bound (λ̅₂̅) 410 and the distributed control system 104 reallocates the remaining power requirements among the other DGs while maintaining optimal dispatch.

FIG. 4B illustrates active power outputs (P₁ 414, P₂ 416, P₃ 418, P₄ 420) of the DGs 108a-108k. Initially, all the DGs 108a-108k participate in the ED. After the load 412 increases at t=2.5s, the power outputs (P₁ 414, P₂ 416, P₃ 418, P₄ 420) adjust, with P₂ 416 reaching its maximum limit. When the load 412 returns to its original level, all the DGs 108a-108k read just their power outputs (P₁ 414, P₂ 416, P₃ 418, P₄ 420) to restore the optimal dispatch.

FIG. 4C illustrates DG bus voltages (V₁ 422, V₂ 424, V₃ 426, V₄ 428) and the average reference voltage (V_{avg}) 430. Despite the power redistribution, the distributed control system 104 successfully regulates the MG's average voltage (V_{avg}) 430 at the nominal value of 200 Volts (V), ensuring that the equality constraint for ED is satisfied. Subsequently, when the total demand decreases back to its initial value, the DGs 108a-108k adjust their power outputs accordingly and P₂ 416 returns to the ED mode. As a result, the equilibrium of all DG's ICs is restored at the optimal value, demonstrating the capability of the distributed control system 104 to handle capacity constraints while maintaining the voltage stability and economic operation.

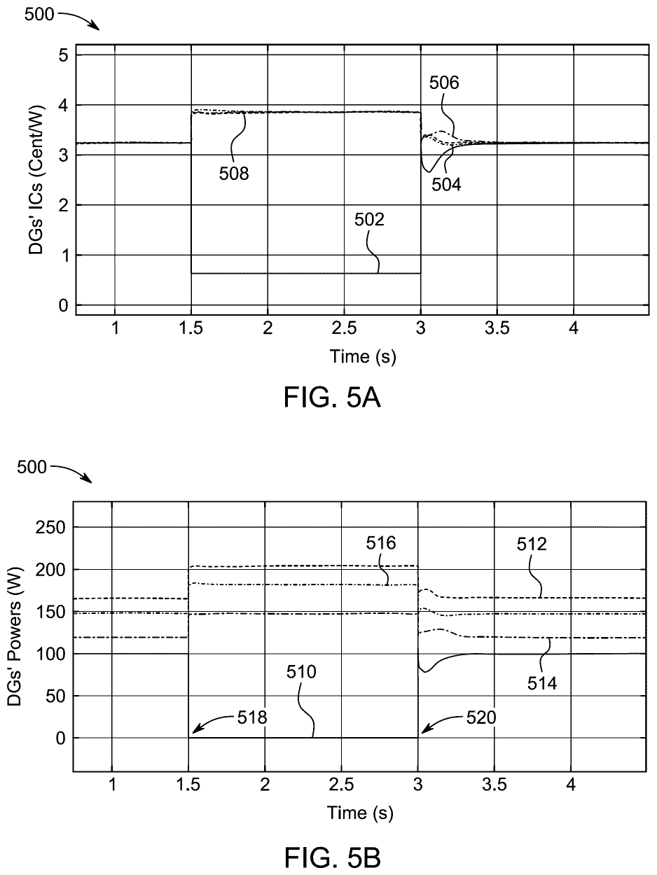

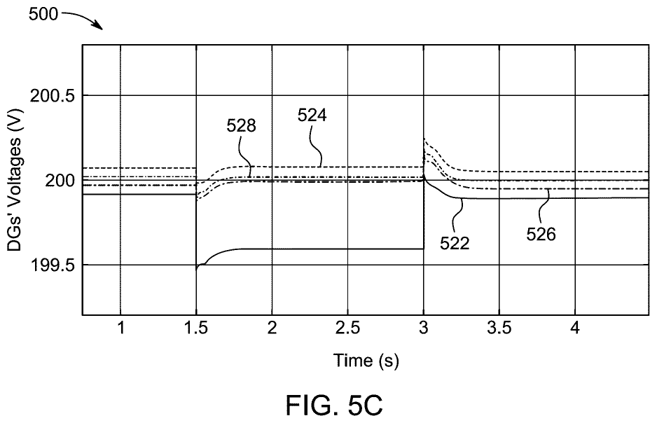

FIGS. 5A-5C illustrate graphical representations 500 of plug-and-play capability of the distributed control system 104, according to certain embodiments. FIG. 5A shows an evolution of ICs (λ₁ 502, λ₂ 504, λ₃ 506, λ₄ 508) over time. Initially, all the DGs 108a-108k operate optimally with equalized ICs. At t=1.5s, DG₁ 108a is disconnected (plugged out) from the MG 102, causing the ICs of the remaining DGs to adjust and balance at a new operating value. At t=3s, DG₁ 108a is reconnected (plugged in), and the ICs re-stabilize to maintain optimal operation.

FIG. 5B depicts power outputs (P₁ 510, P₂ 512, P₃ 514, P₄ 516) of the DGs 108a-108k. When DG₁ 108a is unplugged at t=1.5s 518, its power generation drops to zero, and the remaining DGs adjust their outputs to meet the load demand. Upon DG₁'s reconnection 520 at t=3s, its power contribution is gradually restored, ensuring the optimal ED.

FIG. 5C illustrates voltages (V₁ 522, V₂ 524, V₃ 526, V₄ 528) across the DGs 108a-108k. The MG 102 maintains the voltage stability throughout the plug-and-play operation. A slight voltage deviation occurs when DG₁ 108a is disconnected at t=1.5s, and when it is reconnected at t=3s, but the system 100 quickly stabilizes, ensuring compliance with the ED constraints.

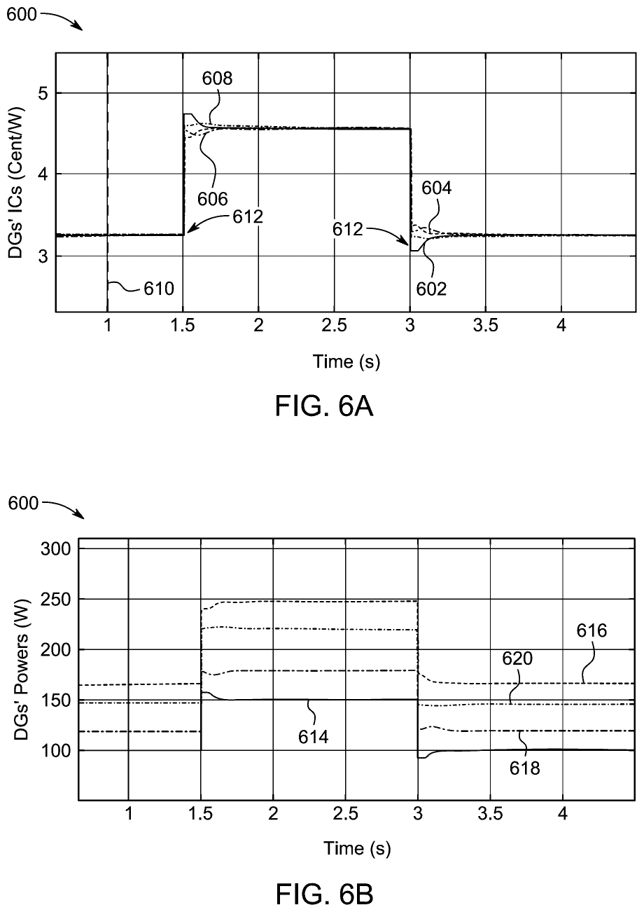

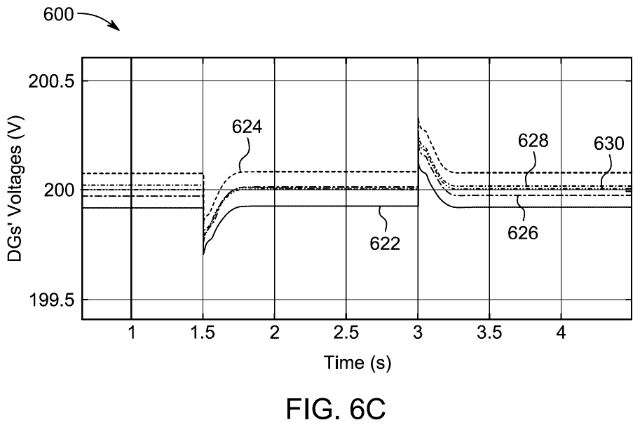

FIGS. 6A-6C illustrate graphical representations 600 of robustness of the distributed control system 104 when a cyber link fails within the MG 102, according to certain embodiments.

Initially, all the DGs 108a-108k operate optimally, ensuring minimal TGC. At t=1s, a cyber link 610 between DG₁ and DG₄ fails, disrupting direct communication between the DGs. However, as shown in FIG. 6A, the distributed control system 104 quickly redistributes the power generation among the remaining DGs to maintain optimal operation.

Referring to FIG. 6A, before the cyber link failure, IC values (λ₁ 602, λ₂ 604, λ₃ 606, λ₄ 608) are equalized, ensuring the ED. After the cyber link failure, a slight deviation occurs in these values as the DGs adjust their power-sharing. Despite the disruption, the ICs (λ₁ 602, λ₂ 604, λ₃ 606, λ₄ 608) gradually converge to a new equilibrium, confirming that the distributed control system 104 effectively balances the system 100 even under communication constraints. Furthermore, load fluctuations 612 have been developed to reveal the superiority of the distributed control system 104.

Referring to FIG. 6B, power outputs (P₁ 614, P₂ 616, P₃ 618, P₄ 620) of all the DGs 108a-108k remain stable before the cyber link failure. However, after t=1s, the MG 102 dynamically adjusts power generation to compensate for a lost cyber link, redistributing the loads among the remaining DGs.

Referring to FIG. 6C, the voltages (V₁ 622, V₂ 624, V₃ 626, V₄ 628), of all the DGs 108a-108k show minor fluctuations immediately after the cyber link failure. Despite the cyber link failure, the average voltage (V_{avg}) 630 remains stable, indicating that the distributed control system 104 successfully regulates the voltages (V₁ 622, V₂ 624, V₃ 626, V₄ 628) across the MG 102.

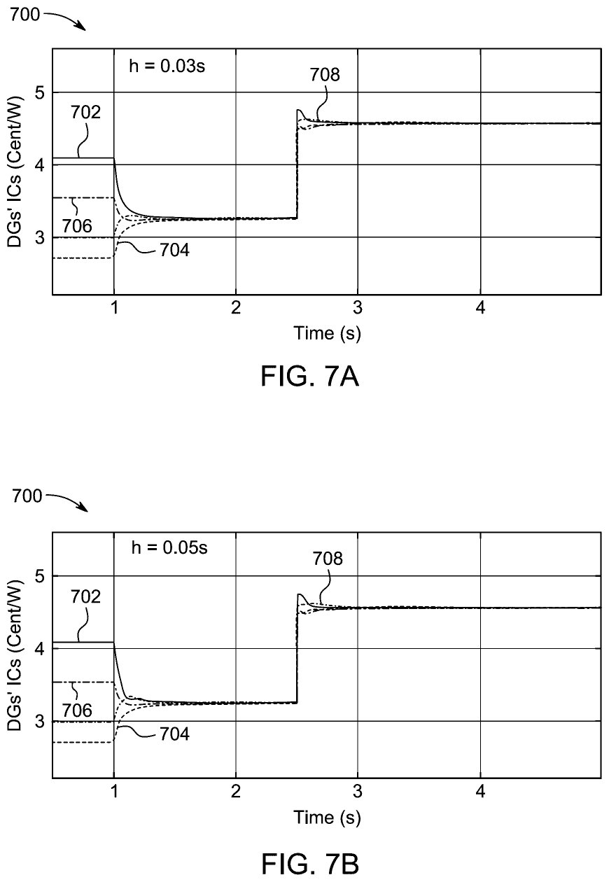

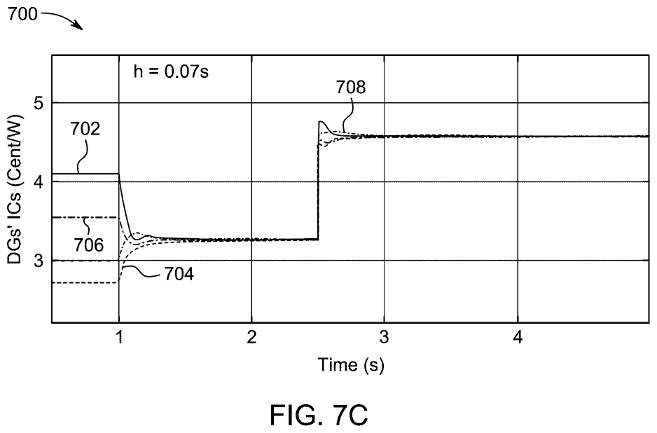

FIGS. 7A-7C illustrate graphical representations 700 of performance of the distributed control system 104 under different time delays, according to certain embodiments. Referring to FIG. 7A, at a low time delay of 0.03s, the ICs (λ₁ 702, λ₂ 704, λ₃ 706, λ₄ 708) of all the DGs 108a-108k quickly reach equilibrium with minimal transient oscillations. The system 100 maintains the ED with a fast convergence rate, indicating effective control.

Referring to FIG. 7B, with a moderate time delay of 0.05s, a slight increase in transient fluctuations is observed. However, the ICs (λ₁ 702, λ₂ 704, λ₃ 706, λ₄ 708) still stabilize efficiently, demonstrating the ability of the distributed control system 104 to handle moderate delays while maintaining the optimal power-sharing.

Referring to FIG. 7C, at a higher delay of 0.07s, the system 100 experiences more pronounced transient fluctuations before reaching the equilibrium. Despite this, the ICs (λ₁ 702, λ₂ 704, λ₃ 706, λ₄ 708) still converge within the fixed time, proving the robustness of the distributed control system 104 in mitigating the impact of communication delays.

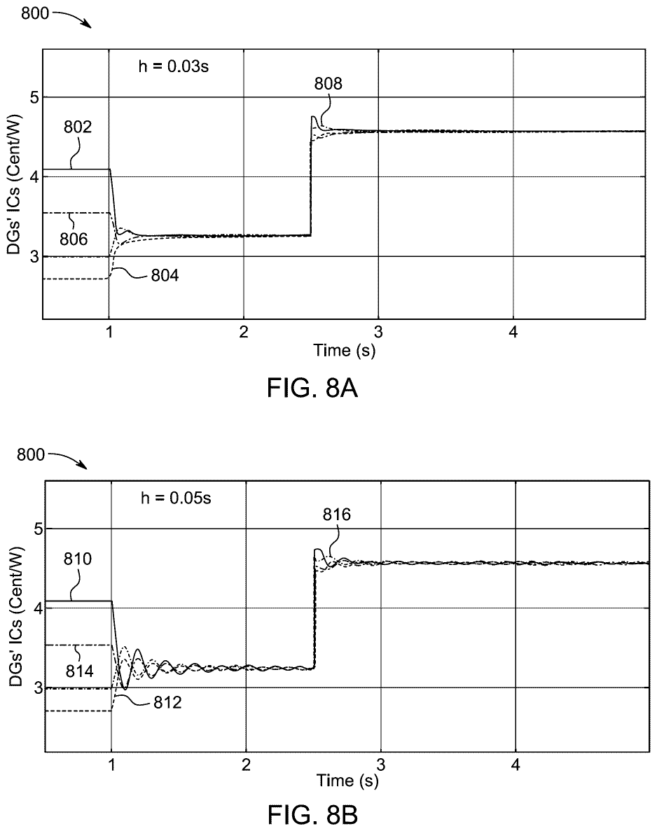

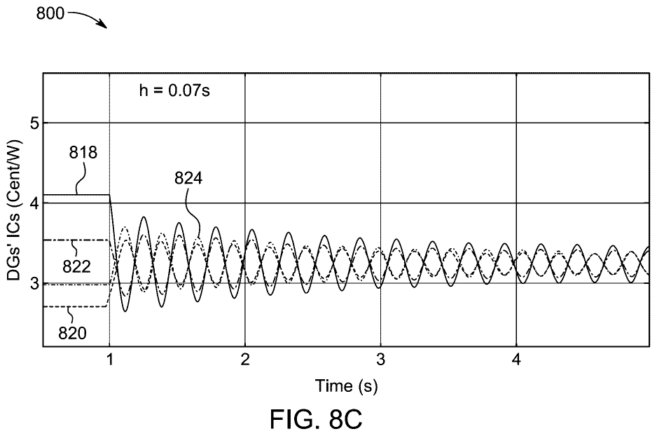

FIGS. 8A-8C illustrate graphical representations 800 of existing fixed-time control strategies under different time delays, according to certain embodiments.

FIG. 8A illustrates the performance of the existing fixed-time control strategy at a 0.03s time delay. While the distributed control system 104 successfully maintains agreement among all DGs' ICs at the optimal value, the ICs (λ₁ 802, λ₂ 804, λ₃ 806, λ₄ 808) under the existing fixed-time control strategy exhibit slightly higher transient oscillations compared to the distributed control system 104, as shown in FIG. 7A. This indicates that the existing fixed-time control strategy is more sensitive to the time delays, leading to increased system dynamics.

FIG. 8B presents a scenario where the time delay is increased to 0.05s. The transient response indicates that as the time delay increases, the convergence speed decreases, and oscillations become more pronounced. The system 100 requires more time to achieve stability, suggesting that the existing fixed-time control strategy struggles to handle increasing delays efficiently. Additionally, the ICs (λ₁ 810, λ₂ 812, λ₃ 814, λ₄ 816) under the existing fixed-time control strategy exhibit more significant fluctuations and slower convergence compared to the ICs of the distributed control system 104, highlighting its higher sensitivity to the communication delays.

FIG. 8C illustrates the performance of the existing fixed-time control strategy under a 0.07s time delay, revealing a critical limitation. In contrast to the distributed control system 104 shown in FIG. 7C, which effectively stabilizes the system 100, the ICs λ₁ 818, λ₂ 820, λ₃ 822, λ₄ 824) under the existing control strategy fails to converge and instead exhibit persistent oscillations. This leads to system instability, emphasizing the inability of the existing control strategy to adapt to high-time delays. Such limitations make it unsuitable for real-world applications where communication latency is unavoidable.

Table 3 further quantifies a performance difference between two control strategies by comparing integral squared error (ISE) values at different time delays. The ISE represents an accumulated error over time, where a lower value indicates better stability and faster convergence. The distributed control system 104 consistently achieves lower ISE values than the existing fixed-time control strategy across all time delays. Notably, at 0.07s, the distributed control system 104 achieves a 43% reduction in ISE compared to the existing fixed-time control strategy, demonstrating its robustness against communication delays.

TABLE 3
ISE values with different time delays

| | Communication time delays | | |
|---|---|---|---|
| Control strategy | 30 ms | 50 ms | 70 ms |
| Distributed Control System 104 | 58.654 | 60.9175 | 63.0342 |
| Existing Fixed-time control | 60.1276 | 69.6707 | 148.0684 |

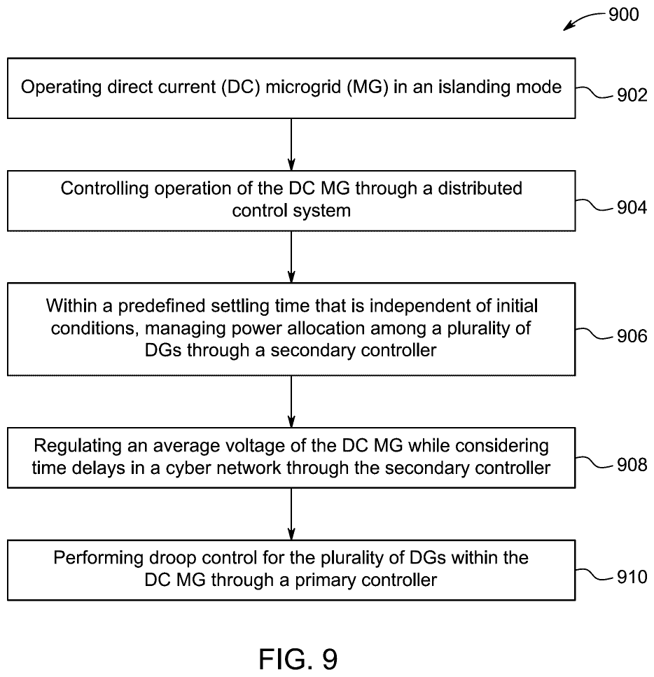

FIG. 9 illustrates a flowchart of a method 900 for operating the DC power generation system 100, according to certain embodiments. The DC power generation system 100 includes the DC MG 102 and the distributed control system 104. The DC MG 102 further includes the DGs 108a-108k interconnected through the transmission lines 118a-118k for supplying the local loads. The DGs 108a-108k include a number of dispatchable DGs and a number of non-dispatchable DGs. The distributed control system 104 includes the primary controller 110 and the secondary controller 112. The distributed control system 104 further includes a cyber network 122 for communication between the DGs 108a-108k. The cyber network 122 includes cyber links 124a-124k used in the cyber network 122 having time delays. The method 900 includes a series of steps. These steps are only illustrative, and other alternatives may be considered where one or more steps are added, one or more steps are removed, or one or more steps are provided in a different sequence without departing from the scope of the present disclosure.

At step 902, the method 900 includes operating the DC MG 102 in the islanded mode. This step includes managing the power generation and power distribution independently, without relying on the main utility grid. The DGs 108a-108k generate the power to meet the demand while maintaining the voltage stability and power-sharing among the DGs 108a-108k. The distributed control system 104 continuously monitors and adjusts the power output of each DG to maintain the system balance, ensuring efficient and stable MG operation. The primary controller 110 of the distributed control system 104, which includes the droop controller 114 and voltage and current control loops 116a-116b, regulates the power distribution, while the voltage reference of the voltage control is tuned by the droop controller 114 to maintain stability. Additionally, each DG communicates with its two nearest neighboring DGs via the cyber links 124a-124k, enabling decentralized decision-making and real-time adjustments for stable operation. Furthermore, the non-dispatchable DGs operate in the MPPT mode, ensuring optimal power extraction, while the dispatchable DGs adjust their power output based on generation costs and power demand, allowing for efficient and cost-effective energy management within the islanded DC MG 102.

At step 904, the method 900 includes controlling the operation of the DC MG 102 through the distributed control system 104. This step includes utilizing the secondary controller 112 of the distributed control system 104, which consists of a distributed secondary controller that determines the nominal voltage of the DC MG 102. The secondary controller 112 includes components, such as a distributed fixed-time cost optimizer 204 and a distributed fixed-time voltage regulator 206, which are critical in ensuring economic efficiency and voltage stability. To suppress the effects of the time delays in the cyber network 122, an Artstein transformation 202 is applied, enhancing the system's resilience against communication latencies.

At step 906, the method 900 includes managing the power allocation among the DGs 108a-108k through the distributed fixed-time cost optimizer 204 of the secondary controller 112, ensuring that the power distribution reaches an optimal state within a fixed settling time independent of initial conditions. This step includes equalizing the ICs of all DGs 108a-108k at the optimal value, thereby minimizing the TGC of the DC MG 102. Each DG operates either at the optimal value of its IC or at its lower or upper power limit, depending on system conditions.

At step 908, the method 900 includes regulating the average voltage of the DC MG 102 while considering the time delays in the cyber network 122, achieved through the distributed fixed-time voltage regulator 206 of the secondary controller 112. This step includes restoring the average voltage of the DC MG 102 to the nominal voltage value within the fixed settling time, ensuring stable operation despite varying load conditions and cyber network delays.

At step 910, the method 900 includes performing droop control for the DGs 108a-108k within the DC MG 102 through the primary controller 110 of the distributed control system 104. This step includes adjusting the power output of each DG based on predefined droop characteristics, maintaining a balance between the power supply and demand while ensuring the voltage and frequency stability.

The first embodiment is illustrated with respect to FIG. 1A-FIG. 2. The first embodiment discloses the direct current (DC) power generation system 100. The system 100 includes a DC microgrid (MG) 102 operating in an islanding mode. The system 100 further includes a distributed control system 104 for controlling operation of the DC MG 102. The DC MG 102 includes a plurality of distributed generators (DGs) 108a-108k interconnected through transmission lines 118a-118k for supplying local loads. The distributed control system 104 includes a primary controller 110 and a secondary controller 112. The distributed control system 104 further includes a cyber network 122 for communication between the plurality of DGs 108a-108k, cyber links 124a-124k used in the cyber network 122 having time delays. Within a predefined settling time that is independent of initial conditions, the secondary controller 112 manages power allocation among the plurality of DGs 108a-108k and regulates an average voltage of the DC MG 102, taking account of the time delays. The primary controller 110 performs droop control for the plurality of DGs 108a-108k within the DC MG 102.

In an aspect, the secondary controller 112 includes a distributed secondary controller that determines a nominal voltage of the DC MG 102. The distributed secondary controller includes a distributed fixed-time cost optimizer 204 and a distributed fixed-time voltage regulator 206.

In an aspect, within a fixed settling time that is independent of initial conditions, the distributed fixed-time cost optimizer 204 equalizes incremental costs of the plurality of DGs 108a-108k at an optimal value, such that a total generation cost of the DC MG 102 is minimized.

In an aspect, each DG of the plurality of DGs 108a-108k operates at the optimal value of the incremental cost or operates at either a lower power limit or an upper power limit of the DG.

In an aspect, within a fixed settling time that is independent of initial conditions, the distributed fixed-time voltage regulator 206 restores the average voltage of the DC MG 102 to a nominal voltage value of the DC MG 102.

In an aspect, Artstein transformation 202 is applied to suppress the time delays of the cyber network 122.

In an aspect, the primary controller 110 includes a droop controller 114 and voltage and current control loops 116a-116b, and a voltage reference of voltage control is tuned by the droop controller 114.

In an aspect, each DG of the plurality of DGs 108a-108k communicates with two nearest neighboring DGs via the cyber links 124a-124k.

In an aspect, the plurality of DGs 108a-108k include a number of dispatchable DGs and a number of non-dispatchable DGs.

In an aspect, the number of non-dispatchable DGs are controlled to operate in a maximum-power-point-tracking (MPPT) mode, and the number of dispatchable DGs are controlled to operate based on a generation cost and a power demand.

The second embodiment is illustrated with respect to FIG. 9. The second embodiment discloses the method 900 for operating a direct current (DC) power generation system 100. The DC power generation system 100 includes a DC microgrid (MG) 102 and a distributed control system 104. The DC MG 102 operates in an islanding mode. The distributed control system 104 controls operation of the DC MG 102. The DC MG 102 includes a plurality of distributed generators (DGs) 108a-108k interconnected through transmission lines 118a-118k for supplying local loads. The distributed control system 104 includes a primary controller 110 and a secondary controller 112. The distributed control system 104 includes a cyber network 122 for communication between the plurality of DGs, cyber links 124a-124k used in the cyber network 122 having time delays. The method 900 includes within a pre-defined settling time that is independent of initial conditions, via the secondary controller 112, managing power allocation among the plurality of DGs 108a-108k. The method 900 further includes, via the secondary controller 112, regulating an average voltage of the DC MG 102, taking account of the time delays. The method 900 further includes via the primary controller 110, performing droop control for the plurality of DGs 108a-108k within the DC MG 102.

In an aspect, the secondary controller 112 includes a distributed secondary controller that determines a nominal voltage of the DC MG 102. The distributed secondary controller includes a distributed fixed-time cost optimizer 204 and a distributed fixed-time voltage regulator 206.

In an aspect, within a fixed settling time that is independent of initial conditions, the distributed fixed-time cost optimizer 204 equalizes incremental costs of the plurality of DGs 108a-108k at an optimal value, such that a total generation cost of the DC MG 102 is minimized.

In an aspect, each DG of the plurality of DGs 108a-108k operates at the optimal value of the incremental cost, or operates at either a lower power limit or an upper power limit of the DG.

In an aspect, within a fixed settling time that is independent of initial conditions, the distributed fixed-time voltage regulator 206 restores the average voltage of the DC MG 102 to a nominal voltage value of the DC MG 102.

In an aspect, Artstein transformation 202 is applied to suppress the time delays of the cyber network 122.

In an aspect, the primary controller 110 includes a droop controller 114 and voltage and current control loops 116a-116b, and a voltage reference of voltage control is tuned by the droop controller 114.

In an aspect, each DG of the plurality of DGs 108a-108k communicates with two nearest neighboring DGs via the cyber links 124a-124k.

In an aspect, the plurality of DGs 108a-108k include a number of dispatchable DGs and a number of non-dispatchable DGs.

In an aspect, the number of non-dispatchable DGs are controlled to operate in a maximum-power-point-tracking (MPPT) mode, and the number of dispatchable DGs are controlled to operate based on a generation cost and a power demand.

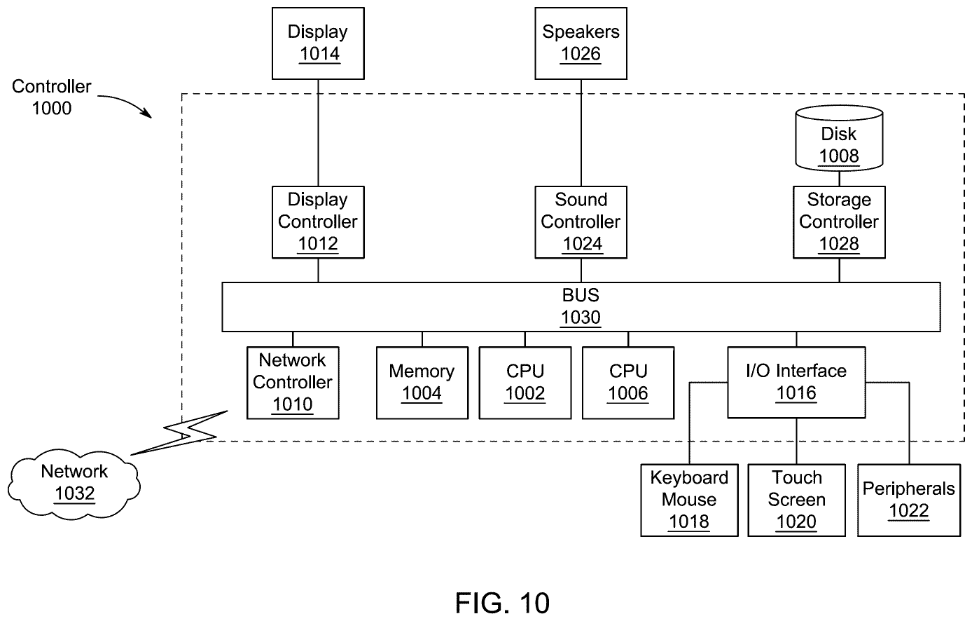

Next, further details of the hardware description of the computing environment according to exemplary embodiments are described with reference to FIG. 10. In FIG. 10, a controller 1000 is described as representative of the system 100 of FIG. 1A in which the controller 1000 includes a CPU 1002 which performs the processes described above/below. The process data and instructions may be stored in memory 1004. These processes and instructions may also be stored on a storage medium disk 1008 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1002, 1006 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 1002 or CPU 1006 may be a Xenon or Core processor from Intel of America or an Opteron processor from AMD of America, or may be other processor types that would be recognized by one of ordinary skill in the art. Alternatively, the CPU 1002, 1006 may be implemented on an FPGA, ASIC, PLD or using discrete logic circuits, as one of ordinary skill in the art would recognize. Further, CPU 1002, 1006 may be implemented as multiple processors cooperatively working in parallel to perform the instructions of the inventive processes described above.

The computing device in FIG. 10 also includes a network controller 1010, such as an Intel Ethernet PRO network interface card from Intel Corporation of America, for interfacing with network 1032. As can be appreciated, the network 1032 can be a public network, such as the Internet, or a private network such as an LAN or WAN network, or any combination thereof and can also include PSTN or ISDN sub-networks. The network 1032 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1012, such as a NVIDIA GeForce GTX or Quadro graphics adaptor from NVIDIA Corporation of America for interfacing with display 1014, such as a Hewlett Packard HPL2445w LCD monitor. A general purpose I/O interface 1016 interfaces with a keyboard and/or mouse 1018 as well as a touch screen panel 1020 on or separate from display 1014. General purpose I/O interface also connects to a variety of peripherals 1022 including printers and scanners, such as an OfficeJet or DeskJet from Hewlett Packard.

A sound controller 1024 is also provided in the computing device such as Sound Blaster X-Fi Titanium from Creative, to interface with speakers/microphone 1026 thereby providing sounds and/or music.

The general purpose storage controller 1028 connects the storage medium disk 1008 with communication bus 1030, which may be an ISA, EISA, VESA, PCI, or similar, for interconnecting all of the components of the computing device. A description of the general features and functionality of the display 1014, keyboard and/or mouse 1018, as well as the display controller 1012, storage controller 1028, network controller 1010, sound controller 1024, and general purpose I/O interface 1016 is omitted herein for brevity as these features are known.

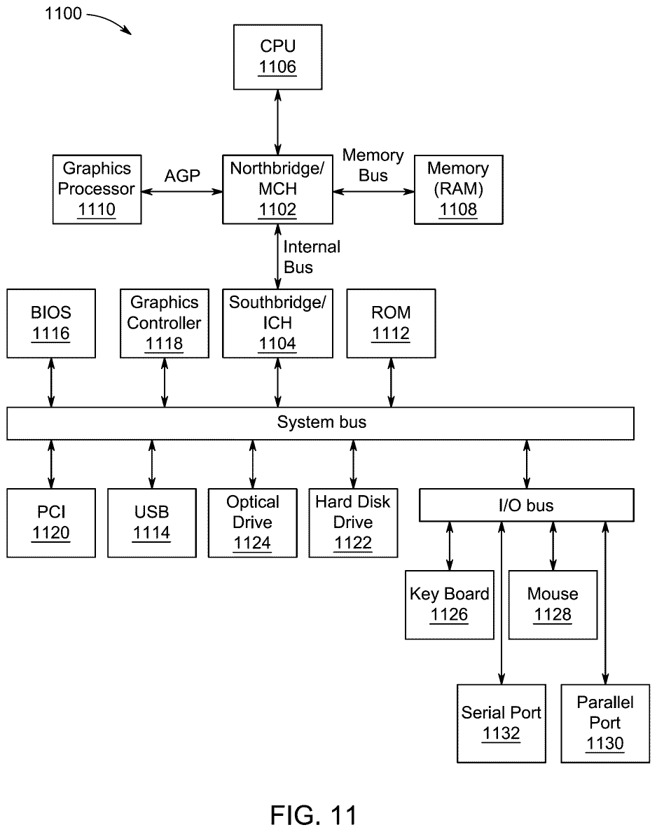

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 11.

FIG. 11 shows a schematic diagram of a data processing system 1100, according to certain embodiments, for performing the functions of the exemplary embodiments. The data processing system 1100 is an example of a computer in which code or instructions implementing the processes of the illustrative embodiments may be located.

In FIG. 11, the data processing system 1100 employs a hub architecture including a north bridge and memory controller hub (NB/MCH) 1102 and a south bridge and input/output (I/O) controller hub (SB/ICH) 1104. The central processing unit (CPU) 1106 is connected to NB/MCH 1102. The NB/MCH 1102 also connects to the memory 1108 via a memory bus, and connects to the graphics processor 1110 via an accelerated graphics port (AGP). The NB/MCH 1102 also connects to the SB/ICH 1104 via an internal bus (e.g., a unified media interface or a direct media interface). The CPU Processing unit 1106 may contain one or more processors and even may be implemented using one or more heterogeneous processor systems.

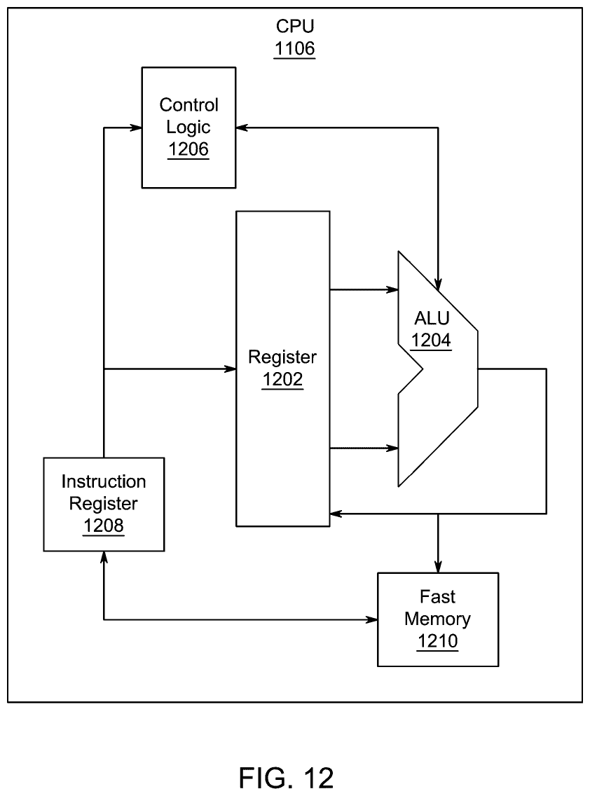

For example, FIG. 12 shows one implementation of CPU 1106. In one implementation, the instruction register 1208 retrieves instructions from the fast memory 1210. At least part of these instructions is fetched from the instruction register 1208 by the control logic 1206 and interpreted according to the instruction set architecture of the CPU 1106. Part of the instructions can also be directed to the register 1202. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 1204 that loads values from the register 1202 and performs logical and mathematical operations on the loaded values according to the instructions. The results from these operations can be feedback into the register and/or stored in the fast memory 1210. According to certain implementations, the instruction set architecture of the CPU 1106 can use a reduced instruction set architecture, a complex instruction set architecture, a vector processor architecture, a very large instruction word architecture. Furthermore, the CPU 1106 can be based on the Von Neuman model or the Harvard model. The CPU 1106 can be a digital signal processor, an FPGA, an ASIC, a PLA, a PLD, or a CPLD. Further, the CPU 1106 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 11, the data processing system 1100 can include that the SB/ICH 1104 is coupled through a system bus to an I/O Bus, a read only memory (ROM) 1112, universal serial bus (USB) port 1114, a flash binary input/output system (BIOS) 1116, and a graphics controller 1118. PCI/PCIe devices can also be coupled to SB/ICH 1104 through a PCI bus 1120.

The PCI devices may include, for example, Ethernet adapters, add-in cards, and PC cards for notebook computers. The Hard disk drive 1122 and optical drive 1124 can use, for example, an integrated drive electronics (IDE) or serial advanced technology attachment (SATA) interface. In one implementation the I/O bus can include a super I/O (SIO) device.

Further, the hard disk drive (HDD) 1122 and optical drive 1124 can also be coupled to the SB/ICH 1104 through a system bus. In one implementation, a keyboard 1126, a mouse 1128, a parallel port 1130, and a serial port 1132 can be connected to the system bus through the I/O bus. Other peripherals and devices that can be connected to the SB/ICH 1104 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

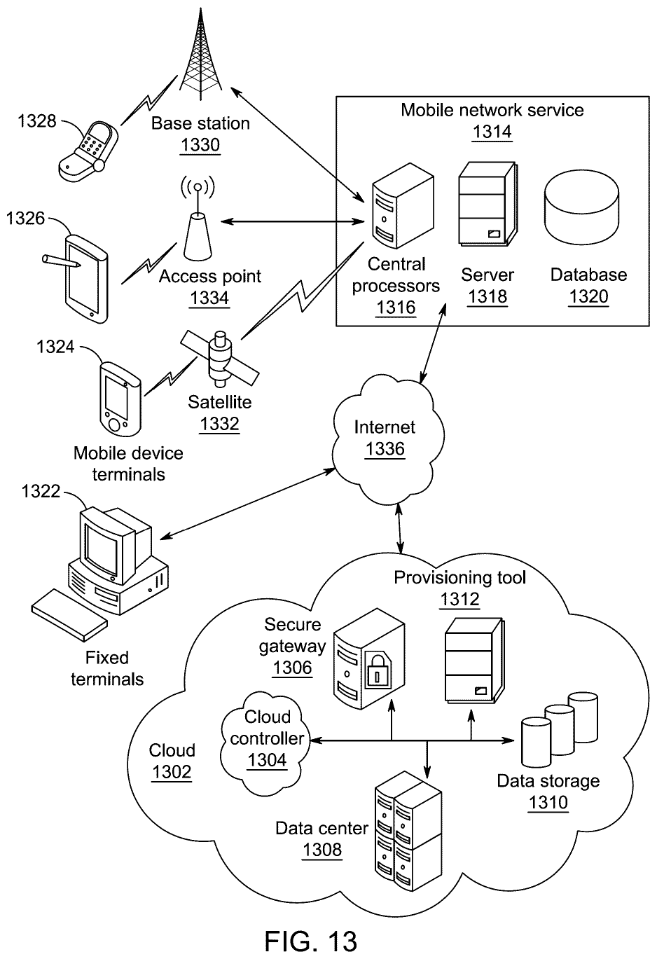

The functions and features described herein may also be executed by various distributed components of a system. For example, one or more processors may execute these system functions, wherein the processors are distributed across multiple components communicating in a network. The distributed components may include one or more client and server machines, such as cloud 1302 including a cloud controller 1304, a secure gateway 1306, a data center 1308, data storage 1310 and a provisioning tool 1312, and mobile network services 1314 including central processors 1316, a server 1318 and a database 1320, which may share processing, as shown by FIG. 13, in addition to various human interface and communication devices (e.g., display monitors 1322, smart phones 1328, tablets 1326, personal digital assistants (PDAs) 1324). The network may be a private network, such as a LAN, satellite 1332 or WAN 1334, or be a public network 1330, may such as the Internet 1336. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A direct current (DC) power generation system, comprising:
a DC microgrid (MG) operating in an islanding mode; and
a distributed control system for controlling operation of the DC MG,
wherein
the DC MG includes a plurality of distributed generators (DGs) interconnected through transmission lines for supplying local loads,
the distributed control system includes a primary controller and a secondary controller,
the distributed control system further includes a cyber network for communication between the plurality of DGs, cyber links used in the cyber network having time delays, and
within a predefined settling time that is independent on initial conditions, the secondary controller manages power allocation among the plurality of DGs and regulates an average voltage of the DC MG, taking account of the time delays, and the primary controller performs droop control for the plurality of DGs within the DC MG.

2. The DC power generation system of claim 1, wherein the secondary controller includes a distributed secondary controller that determines a nominal voltage of the DC MG, and the distributed secondary controller includes a distributed fixed-time cost optimizer and a distributed fixed-time voltage regulator.

3. The DC power generation system of claim 2, wherein within a fixed settling time that is independent on initial conditions, the distributed fixed-time cost optimizer equalizes incremental costs of the plurality of DGs at an optimal value, such that a total generation cost of the DC MG is minimized.

4. The DC power generation system of claim 3, wherein each DG of the plurality of DGs operates at the optimal value of the incremental cost, or operates at either a lower power limit or an upper power limit of the DG.

5. The DC power generation system of claim 2, wherein within a fixed settling time that is independent on initial conditions, the distributed fixed-time voltage regulator restores the average voltage of the DC MG to a nominal voltage value of the DC MG.

6. The DC power generation system of claim 1, wherein Artstein transformation is applied to suppress the time delays of the cyber network.

7. The DC power generation system of claim 1, wherein the primary controller includes a droop controller and voltage and current control loops, and a voltage reference of voltage control is tuned by the droop controller.

8. The DC power generation system of claim 1, wherein each DG of the plurality of DGs communicates with two nearest neighboring DGs via the cyber links.

9. The DC power generation system of claim 1, wherein the plurality of DGs include a number of dispatchable DGs and a number of non-dispatchable DGs.

10. The DC power generation system of claim 9, wherein the number of non-dispatchable DGs are controlled to operate in a maximum-power-point-tracking (MPPT) mode, and the number of dispatchable DGs are controlled to operate based on a generation cost and a power demand.

11. A method for operating a direct current (DC) power generation system, the DC power generation system including a DC microgrid (MG) and a distributed control system,
the DC MG operating in an islanding mode,
the distributed control system controlling operation of the DC MG,
the DC MG including a plurality of distributed generators (DGs) interconnected through transmission lines for supplying local loads,
the distributed control system including a primary controller and a secondary controller,
the distributed control system further including a cyber network for communication between the plurality of DGs, cyber links used in the cyber network having time delays,
the method comprises, within a pre-defined settling time that is independent on initial conditions, via the secondary controller, managing power allocation among the plurality of DGs and regulates an average voltage of the DC MG, taking account of the time delays, and via the primary controller, performing droop control for the plurality of DGs within the DC MG.

12. The method for operating the DC power generation system of claim 11, wherein the secondary controller includes a distributed secondary controller that determines a nominal voltage of the DC MG, and the distributed secondary controller includes a distributed fixed-time cost optimizer and a distributed fixed-time voltage regulator.

13. The method for operating the DC power generation system of claim 12, wherein within a fixed settling time that is independent on initial conditions, the distributed fixed-time cost optimizer equalizes incremental costs of the plurality of DGs at an optimal value, such that a total generation cost of the DC MG is minimized.

14. The method for operating the DC power generation system of claim 13, wherein each DG of the plurality of DGs operates at the optimal value of the incremental cost, or operates at either a lower power limit or an upper power limit of the DG.

15. The method for operating the DC power generation system of claim 12, wherein within a fixed settling time that is independent on initial conditions, the distributed fixed-time voltage regulator restores the average voltage of the DC MG to a nominal voltage value of the DC MG.

16. The method for operating the DC power generation system of claim 11, wherein Artstein transformation is applied to suppress the time delays of the cyber network.

17. The method for operating the DC power generation system of claim 11, wherein the primary controller includes a droop controller and voltage and current control loops, and a voltage reference of voltage control is tuned by the droop controller.

18. The method for operating the DC power generation system of claim 11, wherein each DG of the plurality of DGs communicates with two nearest neighboring DGs via the cyber links.

19. The method for operating the DC power generation system of claim 11, wherein the plurality of DGs include a number of dispatchable DGs and a number of non-dispatchable DGs.

20. The method for operating the DC power generation system of claim 19, wherein the number of non-dispatchable DGs are controlled to operate in a maximum-power-point-tracking (MPPT) mode, and the number of dispatchable DGs are controlled to operate based on a generation cost and a power demand.
